(19) United States
(12) Patent Application Publication
(10) Pub. No.: US 2017/0176644 A1
(43) Pub. Date: Jun. 22, 2017

(54) OPTICAL MEMBER AND METHOD FOR MANUFACTURING THE SAME

(71) Applicant: CANON KABUSHIKI KAISHA, Tokyo (JP)

(72) Inventor: Tomonari Nakayama, Yokohama-shi (JP)

(21) Appl. No.: 15/039,024

(22) PCT Filed: Nov. 14, 2014
(86) PCT No.: PCT/JP2014/080836

§ 371 Date: May 24, 2016

(30) Foreign Application Priority Data
Nov. 27, 2013 (JP) 2013-245198

(51) Int. Cl. G02B 1/111; C03C 17/42; B01J 13/00; C09D 179/08; C09D 1/00

(52) U.S. Cl. CPC G02B 1/111; C09D 179/08; C09D 1/00; B01J 13/0026; C03C 17/42; C03C 2217/425; C03C 2217/73; C03C 2218/116; C03C 2218/113; C03C 2217/77

(57) ABSTRACT

The present invention provides an optical member having an antireflection effect and environmental reliability and a manufacturing method thereof.

The optical member includes a laminated body formed on a surface of a substrate, and the laminated body includes a porous layer or a layer having an uneven structure as a surface layer, a first organic resin layer containing a polymer having an aromatic ring and/or an imide ring in its main chain as a primary component, and a second organic resin layer containing a polymaleimide or a copolymer thereof as a primary component, the first organic resin layer and the second organic resin layer being provided in this order from the substrate to the surface layer.

### TECHNICAL FIELD

The present invention relates to an optical member having antireflection performance and a method for manufacturing the same, and more particularly relates to an optical member having excellent antireflection performance in a region from visible light to near-infrared light and a method for manufacturing the same.

### BACKGROUND ART

A method to obtain an antireflection effect by growing boehmite on a substrate as an antireflection film of an optical member has been known. An antireflection film has been disclosed in NPL 1 in which an aluminum oxide film formed by a liquid phase method (sol-gel method) is processed by a water vapor treatment or a hot-water immersion treatment to form a surface layer having a fine crystal structure of boehmite or the like.

When the refractive index of a substrate is high, a sufficient antireflection effect cannot be obtained only by a fine structure of an aluminum oxide crystal. Hence, a method to improve the antireflection effect was found in which between the substrate and the fine structure, an intermediate layer having an intermediate refractive index between the refractive index of the substrate and that of the fine structure is provided. PTL 1 has disclosed an optical member in which an intermediate layer formed of an organic resin having an aromatic ring and/or an imide ring is provided between a substrate and a fine structure.

In the case in which an antireflection film is formed by a liquid phase method on a curved surface lens having a large angle of view, the thickness of the film at a peripheral portion becomes larger than that of the film at a central portion, and as a result, the antireflection effect at the peripheral portion is degraded. Accordingly, it was found that by disposing two intermediate layers between a substrate and a fine structure, even if the film thickness is changed, an optical element having an antireflection effect which is unlikely to be degraded is formed. PTL 2 has disclosed an optical member in which two intermediate layers, that is, an organic resin layer and an inorganic layer, are provided between a substrate and a fine structure.

However, when the inorganic layer is formed by a liquid phase method, since a high temperature and a long time are required to cure the inorganic layer, damage is done to the organic resin layer provided thereunder, and hence, a problem of degradation in optical characteristics and environmental reliability has occurred.

### CITATION LIST

### Patent Literature

PTL 1 Japanese Patent Laid-Open No. 2008-233880
PTL 2 Japanese Patent Laid-Open No. 2013-47780

### Non-Patent Literature

NPL 1 K Tadanaga, N. Katata, and T. Minami: “Super-Water-Repellent Al₂O₃ Coating Films with High Transparency” J. Am. Ceram. Soc., vol. 80, No. [4], pp. 1040 to 1042 (1997)

### SUMMARY OF INVENTION

In consideration of the circumstances as described above, the present invention provides an optical member having excellent antireflection effect and environmental reliability by using two organic resin intermediate layers and a manufacturing method of the optical member.

To this end, the present invention provides an optical member in which a laminated body is formed on a surface of a substrate, and the laminated body includes a porous layer or a layer having an uneven structure as a surface layer, a first organic resin layer containing as a primary component, a polymer having an aromatic ring and/or an imide ring in its main chain, and a second organic resin layer containing as a primary component, a polymaleimide having a repeating structure represented by the following general formula (1) or a copolymer thereof, the first organic resin layer and the second organic resin layer being provided in this order from the substrate to the surface layer.

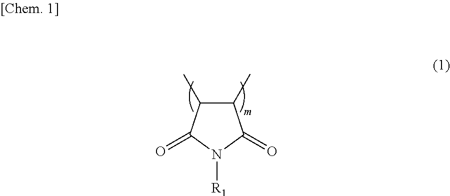

(In the formula (1), R₁ represents a linear, a branched, or a cyclic alkyl or alkenyl group having a 1 to 8 carbon atoms which is unsubstituted or substituted by a phenyl group, a hydroxy group, an alkoxy group, an acetoxy group, a cyclic ether group, an amino group, an alkoxysilyl group, and/or a halogen atom, or a phenyl, a biphenyl, or a naphthyl group which is unsubstituted or substituted by an alkyl group, an alkenyl group, an alkoxy group, an acetoxy group, an alkoxysilyl group, a nitro group, and/or a halogen group. m is an integer of 1 or more.)

In addition, the present invention provides a method for manufacturing an optical member in which a laminated body is formed on a surface of a substrate, and the method for manufacturing an optical member comprises the steps of: applying a solution of a polymer having an aromatic ring and/or an imide ring in its main chain on the substrate, followed by performing drying at 20° C. to 150° C. to form a first organic resin layer; applying a solution of a polymaleimide having a repeating structure represented by the following general formula (1) or a copolymer thereof on the first organic resin layer, followed by performing drying at 20° C. to 150° C. to form a second organic resin layer; and forming a porous layer or a layer having an uneven structure on the second organic resin layer using a silicon oxide particle sol or an aluminum oxide precursor sol.

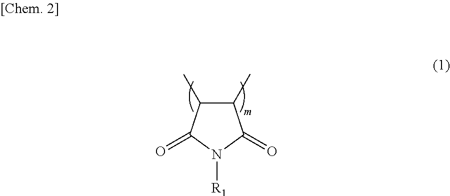

(In the formula (1), R₁ represents a linear, a branched, or a cyclic alkyl or alkenyl group having a 1 to 8 carbon atoms which is unsubstituted or substituted by a phenyl group, a hydroxy group, an alkoxy group, an acetoxy group, a cyclic ether group, an amino group, an alkoxysilyl group, and/or a halogen atom, or a phenyl, a biphenyl, or a naphthyl group which is unsubstituted or substituted by an alkyl group, an alkenyl group, an alkoxy group, an acetoxy group, an alkoxysilyl group, a nitro group, and/or a halogen group. m is an integer of 1 or more.)

Further features of the present invention will become apparent from the following description of exemplary embodiments with reference to the attached drawings.

### BRIEF DESCRIPTION OF DRAWINGS

FIG. 1 is a schematic view showing one embodiment of an optical member of the present invention.

FIG. 2 is a schematic view showing one embodiment of the optical member of the present invention.

FIG. 3 is a graph showing a refractive index distribution according to one embodiment of the optical member of the present invention.

FIG. 4 is a schematic view showing one embodiment of the optical member of the present invention.

FIG. 5 is a schematic view showing one embodiment of the optical member of the present invention.

FIG. 6 is a graph showing the absolute reflectance of a glass substrate surface of Example 1.

FIG. 7 is a graph showing the absolute reflectance of a glass substrate surface of Example 2.

FIG. 8 is a graph showing the absolute reflectance of a glass substrate surface of Example 3.

FIG. 9 is a graph showing the absolute reflectance of a glass substrate surface of Example 4.

FIG. 10 is a graph showing the absolute reflectance of a glass substrate surface of Example 5.

FIG. 11 is a graph showing the absolute reflectance of a glass substrate surface of Comparative Example 1.

FIG. 12 is a graph showing the absolute reflectance of a glass substrate surface of Comparative Example 2.

FIG. 13 is a graph showing the absolute reflectance of a glass substrate surface of Comparative Example 3.

FIG. 14 is a graph showing the absolute reflectance of a glass substrate surface of Comparative Example 4.

FIG. 15 is a graph showing the absolute reflectance of a glass substrate surface of Example 6.

FIG. 16 is a graph showing the absolute reflectance of a glass substrate surface of Comparative Example 5.

FIG. 17 is a graph showing the absolute reflectance of a glass substrate surface of Comparative Example 6.

FIG. 18 is a graph showing the absolute reflectance of a glass substrate surface of Example 7.

### DESCRIPTION OF EMBODIMENTS

Hereinafter, the present invention will be described in detail.

### Optical Member

An optical member of the present invention may be used, for example, as an optical lens, an optical prism, or an optical finder. Among those mentioned above, the optical member of the present invention is preferably used as an optical lens.

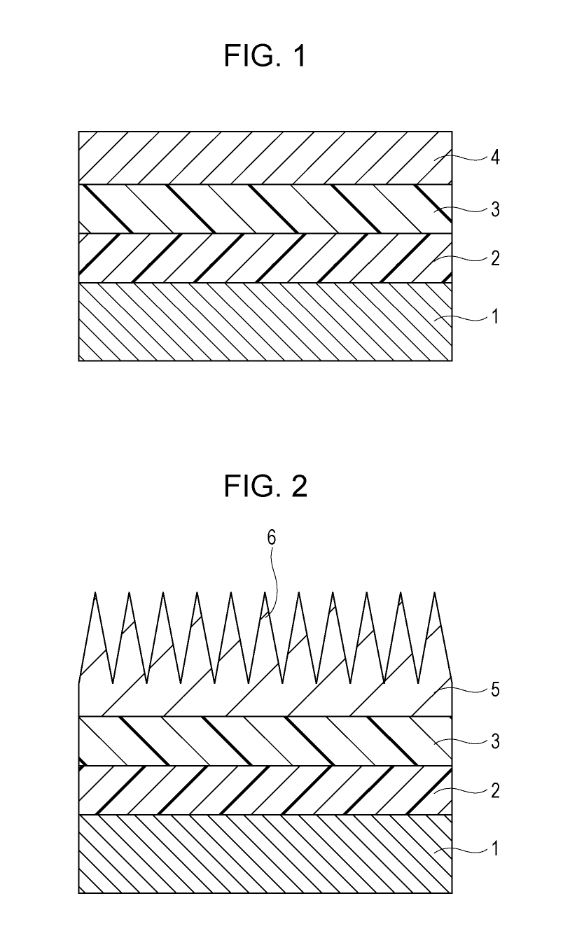

FIG. 1 is a schematic cross-section view showing an optical member according to a first embodiment of the present invention. In the first embodiment, as a surface layer of a laminated body which suppresses reflection of light, a porous layer is used. In FIG. 1, the optical member of the present invention has a laminated body on the surface of a substrate 1. The laminated body is a laminated body in which a first organic resin layer 2 containing a polymer having an aromatic ring and/or an imide ring, a second organic resin layer 3 containing a polymaleimide which has a repeating structure represented by the following general formula (1) or a copolymer thereof, and a porous layer 4 are laminated in this order.

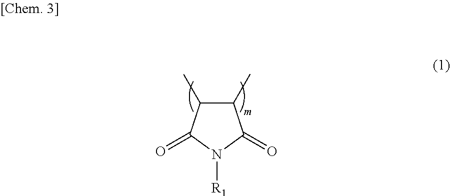

(In the formula (1), R₁ represents a linear, a branched, or a cyclic alkyl or alkenyl group having a 1 to 8 carbon atoms which is unsubstituted or substituted by a phenyl group, a hydroxy group, an alkoxy group, an acetoxy group, a cyclic ether group, an amino group, an alkoxysilyl group, and/or a halogen atom, or a phenyl, a biphenyl, or a naphthyl group which is unsubstituted or substituted by an alkyl group, an alkenyl group, an alkoxy group, an acetoxy group, an alkoxysilyl group, a nitro group, and/or a halogen group. m is an integer of 1 or more.)

Compared to the case in which the porous layer 4 is directly formed on the substrate 1 or the case in which only one of the first organic resin layer 2 and the second organic resin layer 3 is formed between the substrate 1 and the porous layer 4, a high antireflection effect can be obtained by the optical member of the present invention. The thicknesses of the first organic resin layer 2 and the second organic resin layer 3 are each preferably 10 to 100 nm and is preferably changed in the range described above in accordance, for example, with the refractive index of the substrate. When the film thickness is less than 10 nm, the antireflection effect is not improved as compared to that of the case in which the first organic resin layer 2 or the second organic resin layer 3 is not provided, and when the film thickness is more than 100 nm, the antireflection effect is remarkably degraded.

In the optical member of the present invention, the first organic resin layer 2 includes a polymer having an aromatic ring and/or an imide ring in its main chain. As examples of the aromatic ring and the imide ring, the structures represented by the following chemical formulas may be mentioned. On the other hand, a polymer, such as a polystyrene or a poly(benzyl methacrylate), having an imide ring or an aromatic ring in a side chain or a pendant group is not included.

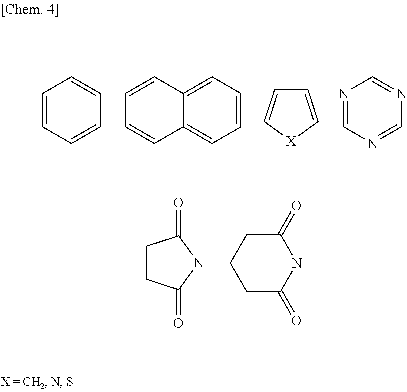

In the polymer having an aromatic ring and/or an imide ring in its main chain, since the aromatic ring and the imide ring each have a planar structure, molecular chains of an organic resin having those structures in its main chain are likely to be oriented in parallel with respect to the substrate in film formation. Hence, even when a film having a thickness of 100 nm or less, such as the first organic resin layer 2 of the present invention, is used, the uniformity of the film thickness and that of the refractive index are high. Furthermore, since having excellent solvent resistance and mechanical characteristics even if curing is performed not at a high temperature, the polymer described above is preferably used as an underlayer when another organic resin layer is laminated thereon.

When a polymer having no aromatic ring nor imide ring in its main chain is used, since the molecular chains are not sufficiently entangled with each other, the solvent resistance is degraded when the film thickness is decreased. In the case as described above, when the second organic resin layer 3 is applied on the first organic resin layer 2, the first organic resin layer 2 may be dissolved out, cracks may be generated, and/or an unexpected mixed layer may be formed between the first organic resin layer 2 and the second organic resin layer 3 in some cases.

As the type of polymer, either a thermosetting resin or a thermoplastic resin may be used as long as having an aromatic ring and/or an imide ring in its main chain. For example, since the refractive index, the film thickness, and the like are not significantly changed by the change in baking conditions, and the amount of a remaining uncured monomer is small, a thermoplastic resin is more preferable.

As preferable examples of a thermoplastic resin having an aromatic ring and/or an imide ring in its main chain, for example, an aromatic polyether, such as a poly(ether ketone) or a poly(ether sulfone), an aromatic polyester such as a poly(ethylene terephthalate), an aromatic polycarbonate, an aromatic polyurethane, an aromatic polyurea, an aromatic polyamide, a thermoplastic polyimide, and a melamine polymer may be mentioned by way of example. Among those mentioned above, since having a high refractive index, an aromatic polyether, an aromatic polysulfide, an aromatic polycarbonate, a thermoplastic polyimide, and a melamine polymer are more preferable.

The refractive index of the first organic resin layer 2 is preferably in a range of 1.6 to 1.9 and more preferably in a range of 1.65 to 1.85. As a preferable example of a material having a refractive index in the range described above, a branched polymer having a melamine structure represented by the following general formula (2) may be mentioned.

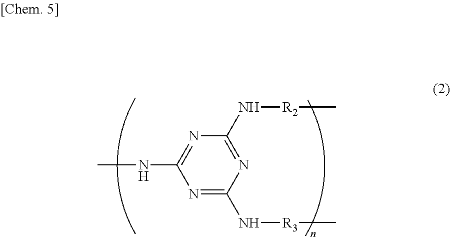

(In the formula, R₂ and R₃ each independently represent a divalent organic group having an aromatic ring or a heterocyclic ring, and n is an integer of 3 or more.)

Since having a high refractive index of more than 1.8 and excellent compatibility with other polymers, the branched polymer having a melamine structure can form an intermediate layer having a wide refractive index range from a medium to a high refractive index by polymer blend.

As long as no phase separation nor the like occurs, polymer blend may be performed between polymers each having an aromatic ring and/or an imide ring in its main chain or between a polymer having an aromatic ring and/or an imide ring in its main chain and a polymer having no aromatic ring nor imide ring in its main chain. In addition, if necessary, polymer blend among at least three types of polymers may also be performed.

A polymer used for the first organic resin layer 2 is preferably soluble in at least one type of solvent selected from cyclohexanone, cyclopentanone, and γ-butyrolactone and is preferably insoluble in at least one type of solvent selected from acetic acid esters. The “soluble in a solvent” of the present invention indicates the case in which at least 1 g of the polymer is dissolved in 100 g of a solvent at 20° C. On the other hand, the “insoluble in a solvent” indicates the case in which the amount of a polymer dissolved in 100 g of a solvent at 20° C. is less than 1 g or the case in which because of the presence of an undissolved polymer, precipitation and/or cloudiness is generated. By the used of a polymer having the solubility as described above for the first organic resin layer 2, when the second organic resin layer 3 is formed on the first organic resin layer 2 by application, the first organic resin layer 2 can be prevented from being dissolved out.

In the optical member of the present invention, the second organic resin layer 3 contains a polymaleimide having a repeating structure represented by the following general formula (1) or a copolymer thereof.

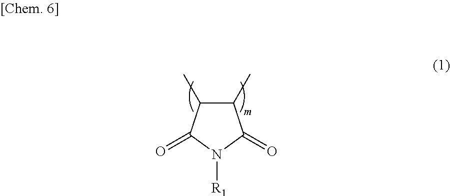

(In the formula (1), R₁ represents a linear, a branched, or a cyclic alkyl or alkenyl group having a 1 to 8 carbon atoms which is unsubstituted or substituted by a phenyl group, a hydroxy group, an alkoxy group, an acetoxy group, a cyclic ether group, an amino group, an alkoxysilyl group, and/or a halogen atom, or a phenyl, a biphenyl, or a naphthyl group which is unsubstituted or substituted by an alkyl group, an alkenyl group, an alkoxy group, an acetoxy group, an alkoxysilyl group, a nitro group, and/or a halogen group. m is an integer of 1 or more.)

Since imide rings of the main chains of the polymaleimide are also oriented to each other, even if the film thickness is 100 nm or less, the uniformity of the film thickness and that of the refractive index are high. Furthermore, because of the presence of the imide rings, even if curing is performed not at a high temperature, the solvent resistance, the moisture resistance, and the mechanical characteristics are excellent. In addition, the refractive index and the solubility to a solvent can be changed by the type of substituent R₁ bonded to the nitrogen atom of the imide ring. In addition, since a maleimide can be copolymerized with various types of acrylates and methacrylates and various types of olefins, such as a cycloolefin and a styrene, the refractive index and the solubility to a solvent can be changed in accordance with the type of co-monomer to be copolymerized. Accordingly, the second organic resin layer 3 having excellent solvent resistance and moisture resistance can be obtained using a polymaleimide or a copolymer thereof which is soluble in a solvent in which the first organic resin layer 2 is not dissolved.

When a polymaleimide copolymer is used, a maleimide copolymerization ratio is preferably 0.5 or more. When the maleimide copolymerization ratio is less than 0.5, the solvent resistance is degraded, desired refractive index and film thickness are not obtained, and the reflectance is not decreased.

The polymer used for the second organic resin layer 3 is preferably soluble in at least one type of solvent selected from acetic acid esters and insoluble in at least one type of solvent selected from alcohols having 3 to 7 carbon atoms. By the use of a polymer having the solubility as described above for the second organic resin layer 3, when the second organic resin layer 3 is formed on the first organic resin layer 2 by application, the two layers can be laminated to each other without dissolving the first organic resin layer 2 and being mixed with each other.

The molecular weight of the polymaleimide of the present invention or the copolymer thereof is preferably 3,000 to 100,000 in number average molecular weight. When the number average molecular weight is less than 3,000, the strength of the film may be insufficient in some cases, and when the number average molecular weight is more than 100,000, the viscosity of the polymer in the form of a solution is too high to form a thin film. The number average molecular weight of the maleimide copolymer is more preferably 5,000 to 50,000.

The refractive index of the second organic resin layer 3 is preferably in a range of 1.4 to 1.7 and more preferably 1.45 to 1.65.

The porous layer 4 formed on the second organic resin layer 3 of the present invention preferably has a refractive index of 1.4 or less. As the porous layer, a film formed by depositing particles of silicon oxide or magnesium fluoride may be used. The particles also include hollow particles. Among those mentioned above, a layer formed by depositing particles of silicon oxide is preferably used.

The refractive index of the substrate of the present invention is preferably 1.45 to 1.7 and more preferably 1.5 to 1.7.

In addition, when the refractive indices of the first organic resin layer 2, the second organic resin layer 3, and the porous layer 4 (or the layer having an uneven structure) are represented by n1, n2, and n3, respectively, in the optical member, n1>n2>n3 is preferably satisfied. When the above condition is satisfied, the optical member has excellent antireflection performance.

FIG. 2 is a schematic cross-section view showing an optical member according to a second embodiment of the present invention. In the second embodiment, a layer having irregularities is used as the surface layer of the laminated body. In the second embodiment, except that the surface layer of the laminated body is changed to a layer having irregularities, the physical properties, the conditions, and the like described in the first embodiment may also be used. In the optical member of the present invention shown in FIG. 2, the first organic resin layer 2, the second organic resin layer 3, and a layer 5 having irregularities are laminated in this order on the surface of the substrate 1. The layer 5 having irregularities may have projections 6. The projection 6 is preferably formed from a crystal containing aluminum oxide as a primary component. In this specification, the “crystal containing aluminum oxide” indicates a crystal precipitated and grown by a peptization action done on a surface layer of an aluminum oxide film. That is, when a film containing aluminum oxide as a primary component is immersed in hot water, the surface layer thereof receives a peptization action, so that the crystal thus precipitated and grown forms a new surface layer of the aluminum oxide film.

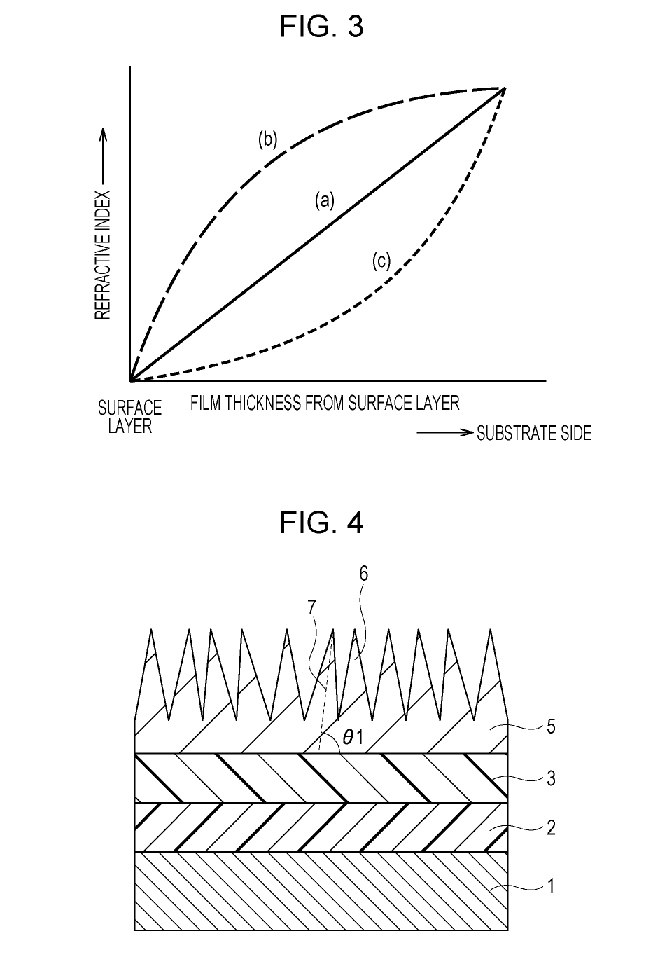

The layer 5 having irregularities is preferably a layer in which the refractive index is continuously increased from a surface layer side to a substrate side, and as shown in FIG. 3, the change in refractive index with respect to the film thickness is shown by a straight line such as (a) or a curved line such as (b) or (c). Since the refractive index is continuously increased from the surface layer side to the substrate side, compared to the case in which the refractive index is increased in a stepwise from the surface layer side to the substrate side by lamination of layers, an effect of decreasing the reflectance is significant.

The layer 5 having projections is preferably formed from a crystal containing as a primary component, an aluminum oxide, an aluminum hydroxide, or a hydrate thereof. In particular, as a preferable crystal, boehmite may be mentioned. In this specification, an aluminum oxide, an aluminum hydroxide, or a hydrate thereof is called “aluminum oxide”. In addition, in the layer 5 having projections, crystals having various sizes are randomly disposed, and the top end portion of the layer 5 forms the projections 6. Hence, in order to change the height, the size, and the angle of the projection 6, and the gap between the projections 6, the precipitation and the growth of the crystal are necessarily controlled. The layer 5 having projections may be divided into the projections 6 and a lower layer located thereunder in some cases. The lower layer as described above is preferably a layer containing only aluminum oxide or aluminum oxide together with 30 percent by moles or less of ZrO₂, SiO₂, TiO₂, ZnO, or MgO.

The case in which the substrate 1 is a flat plate, a film, a sheet, or the like, each having a flat surface, is shown in FIG. 4. The projections 6 are preferably disposed so that the average of angles θ1 (acute angles) with respect to the surface of the substrate, that is, the angles each between a tilting direction 7 of the projection 6 and the surface of the substrate, is 45° to 90° and preferably 60° to 90°.

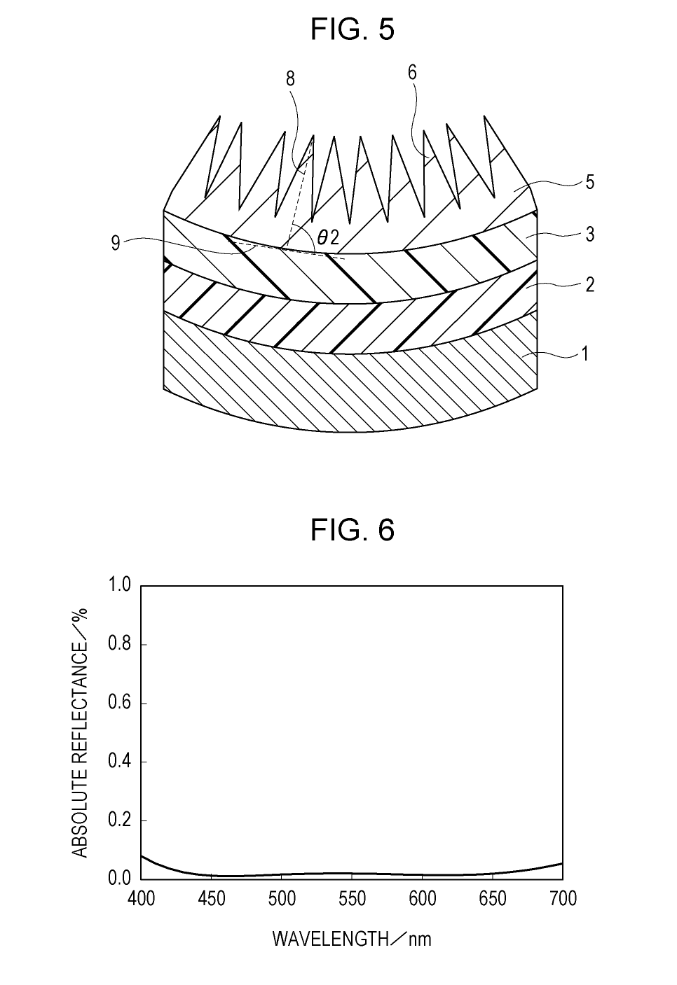

In addition, the case in which the substrate 1 has a two-dimensional or a three-dimensional curved surface is shown in FIG. 5. The projections 6 are preferably disposed so that the average of angles θ2 each between a tilting direction 8 of the projection 6 and a tangent line 9 of the surface of the substrate is 45° to 90° and preferably 60° to 90°. In addition, although the angles θ1 and θ2 each may be more than 90° depending on the tilting of the projection 6, in this case, measured angles of 90° or less are employed.

The thickness of the layer 5 having projections is preferably 20 to 1,000 nm and more preferably 50 to 1,000 nm. When the thickness of the layer 5 having projections is 20 to 1,000 nm, the antireflection performance by the projections 6 is effective, and in addition, the mechanical strengths of the projection 6 may not be degraded, and the manufacturing cost thereof can be advantageously reduced. In addition, when the thickness of the layer is set to 50 to 1,000 nm, it is more preferable since the antireflection performance can be further improved.

The area density of the irregularities of the present invention is also important, an average surface roughness Ra′ obtained by surface expansion of the center line average roughness corresponding to the area density is preferably 5 nm or more, more preferably 10 nm or more, and even more preferably 15 nm to 100 nm, and a surface area ratio Sr is preferably 1.1 or more, more preferably 1.15 or more, and even more preferably 1.2 to 3.5.

The area density of the irregularities may be evaluated by a scanning probe microscope (SPM). By the SPM observation, the average surface roughness value Ra′ obtained by surface expansion of the center line average roughness Ra of the layer 5 having projections and the surface area ratio Sr can be obtained. That is, the average surface roughness Ra′ (nm) is obtained in such a way that the center line average roughness Ra defined by JIS B 0601 is applied to the measuring surface and is then three-dimensionally expanded. The average surface roughness Ra′ (nm) is expressed as the “average of absolute values of deviations each from the reference plane to a designated plane” and is represented by the following equation (1).

$$\begin{matrix}[ Math . 1 ] & \\ {Ra}^{′} = \frac{1}{{S}_{0}} {\int }_{{Y}_{B}}^{{Y}_{T}} {\int }_{{X}_{L}}^{{X}_{R}} \vert F ( X , Y ) - {Z}_{o} \vert dxdy & ( 1 )\end{matrix}$$

Ra′: Average surface roughness (nm)
Sₒ: Area when the measuring surface is supposed to be ideally flat, |X_{R}−X_{L}|×|Y_{T}−Y_{B}|,
F(X,Y): Height at the measurement point (X,Y), X:X coordinate, Y:Y coordinate
X_{L} to X_{R}: X coordinate range of the measuring surface
Y_{B} to Y_{T}: Y coordinate range of the measuring surface
Zₒ: Average height in the measuring surface

In addition, the surface area ratio Sr can be obtained by Sr=S/Sₒ [Sₒ: the area when the measuring surface is ideally flat, and S: the surface area of an actual measuring surface]. In addition, the surface area of the actual measuring surface is obtained as follows. First, the surface area is divided into minute triangles each formed of the closest three data points (A, B, C), and an area ΔS of each minute triangle is obtained using a vector product as follows. ΔS(ΔABC)=[s(s−AB) (s−BC) (s−Ac)]×0.5 [In this formula, AB, BC, and Ac represent the individual lengths, and S≡0.5×(AB+BC+AC) holds]. The sum of the ΔS indicates the surface area S. When the area density Ra′ of the projections 6 is 5 nm or more, and Sr is 1.1 or more, the antireflection effect by the projections 6 can be obtained. In addition, when Ra′ is 10 nm or more, and Sr is 1.15 or more, the antireflection effect thereof is higher than that of the former described above. Furthermore, when Ra′ is 15 nm or more, and Sr is 1.2 or more, the antireflection effect can be practically used. However, when Ra′ is 100 nm or more, and Sr is 3.5 or more, a scattering effect of the projection 6 becomes significant as compared to the antireflection effect thereof, and as a result, sufficient antireflection performance may not be obtained.

In the optical member of the present invention, besides the layers described above, layers imparting various functions may also be further provided. For example, in order to improve the film hardness, a hard coat layer may be provided on the layer 5 having projections, or a water repelling film layer of a fluoroalkyl silane or an alkyl silane may be provided in order to prevent adhesion of stains or the like. In addition, in order to improve the adhesion between the substrate and a layer primarily formed of a polyimide, an adhesive layer and/or a primer layer may also be provided.

### Method for Manufacturing Optical Member

In a method for manufacturing the optical member of the present invention, a step is performed in which after a solution of the polymer having an aromatic ring and/or an imide ring in its main chain is applied on the substrate, the first organic resin layer is formed by drying the applied solution at 20° C. to 150° C. Subsequently, a step is performed in which after a solution of the maleimide or the copolymer thereof is applied on the first organic resin layer, the second organic resin layer is formed by drying the applied solution at 20° C. to 150° C. Furthermore, a step of forming the porous layer or the layer having an uneven structure is performed using a silicon oxide particle sol or an aluminum oxide precursor sol.

As the substrate 1 used in the present invention, a lens, an inorganic glass, a resin, a glass mirror, a resin-made mirror, or the like may be mentioned by way of example. As a representative resin substrate, for example, there may be mentioned a film or a molded article of a thermoplastic resin, such as a polyester, a triacetyl cellulose, an acetic acid cellulose, a poly(ethylene terephthalate), a polypropylene, a polystyrene, a polycarbonate, a polysulfone, a polyacrylate, a polymethacrylate, an ABS resin, a poly(phenylene oxide), a polyurethane, a polyethylene, a polycycloolefin, or a poly(vinyl chloride). In addition, for example, a cross-linked film or a cross-linked molded article obtained from various thermosetting resins, such as an unsaturated polyester resin, a phenol resin, a cross-linkable polyurethane, a cross-linkable acrylic resin, and a cross-linkable saturated polyester resin. As a particular example of the inorganic glass, for example, a non-alkaline glass, an alumina silicate glass, a boric acid glass, a barium oxide-containing glass, a lanthanum oxide-containing glass, or a titanium oxide-containing glass may be mentioned. As the substrate used in the present invention, any material may be used as long as capable of being finally formed into a shape suitable for the purpose of use; a flat plate, a film, a sheet, or the like may be used; and a substrate having a two-dimensional or a three-dimensional curved surface may also be used. Although the thickness may be appropriately determined and is generally 5 mm or less, the thickness is not limited thereto.

The polymer having an aromatic ring and/or an imide ring in its main chain, which is used for forming the first organic resin layer, may be formed by the following method other than a polyimide. That is, synthesis can be performed by a polyaddition reaction or a polycondensation reaction of a single monomer having an aromatic ring or between a bifunctional monomer having an aromatic ring and a bifunctional monomer having a functional group different therefrom. The type of polymer may be determined by the type of functional group, and for example, an aromatic polycarbonate may be synthesized by a polycondensation reaction between an aromatic monomer, such as bisphenol A, and phosgene. An aromatic polyurethane may be synthesized by a polyaddition reaction between diphenylmethane diisocyanate and a diol.

Although a polyimide may also be synthesized by a polyaddition reaction or a polycondensation reaction of a monomer having an imide ring, synthesis is generally performed by a polyaddition reaction and a polycondensation reaction of an acid dianhydride and a diamine. In particular, a polyimide may be formed to satisfy required properties by selecting combination between various types of monomers, and for example, when an aliphatic chain, an alicyclic structure, or a fluoroalkyl group is introduced into a diamine and/or an acid dianhydride, a thermoplastic polyimide can be obtained which is transparent in a visible light region and which is soluble in a solvent. In particular, when an acid dianhydride having an alicyclic structure is used as the acid dianhydride, and at least one of various structures, such as a siloxane structure, an aliphatic chain, an alicyclic structure, and an aromatic ring, is introduced into the diamine, the refractive index may also be arbitrarily changed from 1.5 to 1.7.

As examples of the acid dianhydride used for the synthesis of the thermoplastic polyimide, for example, there may be mentioned an aromatic acid dianhydride, such as pyromellitic anhydride, 3,3′-biphthalic anhydride, 3,4′-biphthalic anhydride, 3,3′,4,4′-benzophenone-tetracarboxylic dianhydride, 3,3′,4,4′-diphenyl sulfone tetracarboxylic dianhydride, 4,4′-(hexafluoroisopropylidene)diphthalic anhydride, or 4,4′-oxydiphthalic anhydride; and an aliphatic acid dianhydride, such as meso-butane-1,2,3,4-tetracarboxylic dianhydride, 1,2,3,4-cyclobutanetetracarboxylic dianhydride, 1,2,3,4-cyclopentanetetracarboxylic dianhydride, 1,2,4,5-cyclohexanetetracarboxylic dianhydride, bicyclo[2.2.2]oct-7-ene-2,3,5,6-tetracarboxylic dianhydride, bicyclo[2.2.2]octane-2,3,5,6-tetracarboxylic dianhydride, bicyclo[2.2.1]heptane-2,3,5,6-tetracarboxylic dianhydride, 5-(2,5-dioxotetrahydrofuryl)-3-methyl-3-cyclohexene-1,2-dicarboxylic anhydride, or 4-(2,5-dioxotetrahydrofuran-3-yl)-1,2,3,4-tetrahydronaphthalene-1,2-dicarboxylic anhydride. In order to improve the solubility, coating properties, and transparency of the polyimide, 3,3′,4,4′-diphenyl sulfone tetracarboxylic dianhydride, 4,4′-(hexafluoroisopropylidene)diphthalic anhydride, 1,2,3,4-cyclobutanetetracarboxylic dianhydride, bicyclo[2.2.2]octane-2,3,5,6-tetracarboxylic dianhydride, bicyclo[2.2.1]heptane-2,3,5,6-tetracarboxylic dianhydride, 5-(2,5-dioxotetrahydrofuryl)-3-methyl-3-cyclohexene-1,2-dicarboxylic anhydride, and 4-(2,5-dioxotetrahydrofuran-3-yl)-1,2,3,4-tetrahydronaphthalene-1,2-dicarboxylic anhydride are more preferable.

As examples of the diamine used for the synthesis of the thermoplastic polyimide, for example, there may be mentioned an aromatic diamine, such as m-phenylenediamine, p-phenylenediamine, 3,4′-diaminodiphenyl methane, 4,4′-diaminodiphenyl methane, 4,4′-diamino-3,3′-dimethyldiphenyl methane, o-tolidine, m-tolidine, 4,4′-diaminobenzophenone, 1,1-bis(4-aminophenyl)cyclohexane, 3,4′-diaminodiphenyl ether, 4,4′-diaminodiphenyl ether, 1,4-bis(4-aminophenoxy)benzene, 1,3-bis(4-aminophenoxy)benzene, 2,2-bis[4-(4-aminophenoxy)phenyl]propane, 4,4′-bis(4-aminophenoxy)biphenyl, bis[4-(4-aminophenoxy)phenyl]sulfone, 4,4′-bis(3-aminophenoxy)biphenyl, bis[4-(4-aminophenoxy)phenyl]sulfone, 9,9-bis(4-aminophenyl)fluorene, 2,2-bis(4-aminophenyl)hexafluoropropane, 2,2-bis[4-(4-aminophenoxy)phenyl]hexafluoropropane, or 2,2′-bis(trifluoromethyl)benzidine; an aliphatic diamine, such as 1,4-diaminobutane, 1,5-diaminopentane, 1,3-cyclohexanediamine, 1,4-cyclohexanediamine, 4,4′-methylenebis(cyclohexylamine), 4,4′-methylenebis(2-methylcyclohexylamine), or 1,4-bis(aminomethyl)cyclohexane; and a diamine containing a —Si—O—Si-group, such as 1,3-bis(3-aminopropyl)tetramethyl disiloxane or 1,4-bis(3-aminopropyldimetnylsilyl)benzene. In view of adhesion to an inorganic substrate, such as a glass, at least a —Si—O—Si-group-containing diamine, such as 1,3-bis(3-aminopropyl)tetramethyl disiloxane or 1,4-bis(3-aminopropyldimetnylsilyl)benzene, is more preferably contained.

Although the melamine polymer may also be synthesized by a method similar to that described above, in order to achieve both a high refractive index and solubility to a solvent, a branched polymer is preferably used.

A branched melamine polymer can be synthesized from a trifunctional monomer having a triazine ring, which is one type of aromatic ring, and a bifunctional monomer having different functional groups. As a representative example, a polycondensation reaction between cyanuric chloride and a diamine may be mentioned. As the diamine used for synthesis of the melamine polymer, various diamines used for synthesis of the above polyimide may be selected.

As a solvent used for the synthesis of the polymer having an aromatic ring and/or an imide ring in its main chain, a solvent which dissolves monomers and a synthesized polymer may be used. For example, an aprotic polar solvent, such as N,N-dimethylformamide, N,N-dimethylacetamide, or N-methyl-2-pyrrolidone, may be used.

Although a solution obtained by the polymer synthesis may be used without performing any additional treatment, a polymer powder which is re-precipitated once in a poor solvent and is then filtrated and dried may be again dissolved in a solvent for the purpose of use. In order to remove various types of chemical reagents and unreacted monomers used for polymerization, re-precipitation is preferably performed with an alcohol. In addition, the polymer solution and/or an isolated polymer powder is preferably dried at a temperature of 50° C. to 150° C. in the air or under reduced pressure to remove the solvent and the like.

A preferable solvent used for a solution of the polymer having an aromatic ring and/or an imide ring in its main chain is cyclopentanone, a cyclohexanone, or γ-butyrolactone, and the total of those solvents is preferably 50 to 100 percent by mass of the total solvent.

In addition, besides the solvents mentioned above, for example, there may be used as solvents, ketones, such as 2-butanone and methyl isobutyl ketone; esters, such as ethyl acetate, n-butyl acetate, 1-methoxy-2-acetoxypropane, 2-methoxy ethyl acetate, 2-ethoxy ethyl acetate, and lactates such as methyl lactate, ethyl lactate, and propyl lactate; ethers, such as tetrahydrofuran, dioxane, and diisopropyl ether; various aromatic hydrocarbons, such as toluene, xylene, and ethylbenzene; chlorinated hydrocarbons, such as chloroform, methylene chloride, and tetrachloroethane; N-methylpyrrolidone, N,N-dimethylformamide, N,N-dimethylacetamide, dimethyl sulfoxide, and sulfolane. Furthermore, an alcohol, such as 1-butanol, methyl cellosolve, diglyme, or methoxypropanol, may also be used by mixing.

With the polymer solution containing a polymer having an aromatic ring and/or an imide ring in its main chain, a component other than the polymer having an aromatic ring and/or an imide ring in its main chain may be mixed. In this case, the content of the polymer having an aromatic ring and/or an imide ring in its main chain is preferably 60 to 100 percent by mass of the total nonvolatile component including the polymers.

A polymer having no aromatic ring nor imide ring may also be added as long as being compatible with the polymer having an aromatic ring and/or an imide ring in its main chain. As examples of the polymer having no aromatic ring nor imide ring, for example, there may be mentioned various types of polyacrylates, various types of polymethacrylates, polystyrenes, aliphatic polyesters, aliphatic polyurethanes, aliphatic polyethers, and polycycloolefins. The content of the polymer having no aromatic ring nor imide ring is 0 to less than 40 percent by mass of the total nonvolatile component including the polymers, and when the content is 40 percent by mass or more, the solvent resistance and the mechanical characteristics are remarkably degraded. The content is more preferably 0 to less than 20 percent by mass.

Although a component other than the polymer may be mixed with the polymer solution, the content of the component is preferably less than 20 percent by mass of the total nonvolatile component including the polymers. When the content is 20 percent by mass or more, the transparency, the film strength, and the uniformity of the film thickness are degraded. The content is more preferably 0 to less than 10 percent by mass. As the component other than the polymer, for example, a silane coupling agent or a phosphoric ester may be mentioned in order to improve the adhesion. In addition, for example, in order to suppress the coloring in a heat treatment, a phenolic antioxidant may also be added. In order to adjust the refractive index and to increase the film hardness, a small amount of inorganic particles, such as SiO₂, TiO₂, ZrO₂, ZnO, MgO, and/or Al₂O₃, may be added.

As a method for applying the polymer solution, an known coating method, such as a dipping method, a spin coating method, a spraying method, a printing method, a flow coating method, or a method in combination therebetween, may be appropriately used.

In the step of forming the first organic resin layer containing the polymer having an aromatic ring and/or an imide ring in its main chain, an applied polymer solution is dried at 20° C. to 150° C. under normal pressure or reduced pressure. As a drying method performed while the applied polymer solution is left stand still or is rotated, air drying, drying using a hot-wind circulating oven or a muffle furnace, or drying by irradiation of light, such as infrared rays or microwaves, radiation rays, or electromagnetic rays, may be appropriately selected.

The polymaleimide or the copolymer thereof which is used to form the second organic resin layer may be synthesized in a solution using a maleimide monomer with or without another monomer by addition polymerization in the presence of a polymerization initiator.

Examples of the maleimide monomer may be mentioned below.

For example, there may be mentioned N-methylmaleimide, N-ethylmaleimide, N-propylmaleimide, N-isopropylmaleimide, N-butylmaleimide, N-tert-butylmaleimide, N-(1-methylpropyl)maleimide, N-(1-prenyl)maleimide, N-cyclohexylmaleimide, N-benzylmaleimide, N-(1-phenylethyl)maleimide, N-(2-furylmethyl)maleimide, N-(2-hydroxyethyl)maleimide, N-(2-methoxyethyl)maleimide, N-(2-acetoxyethyl)maleimide, N-(2-aminoethyl)maleimide, N-(2-aminopropyl)maleimide, N-(3-chloropropyl)maleimide, N-phenylmaleimide, N-(p-tolyl)maleimide, N-(2-methoxyphenyl)maleimide, 1-(4-methoxyphenyl)-3-pyrroline-2,5-dione, 1-(2,4-dimethylphenyl)-3-pyrroline-2,5-dione, 4-maleimidephenol, 1-(2-chlorophenyl)-1H-pyrrole-2,5-dione, and N-(1-pyrenyl)maleimide.

Those maleimide monomers may be used alone, or at least two types thereof may be used in combination. In view of polymer processability, refractive index, and thin-film resistance, for example, N-methylmaleimide, N-ethylmaleimide, N-propylmaleimide, N-tert-butylmaleimide, N-cyclohexylmaleimide, N-benzylmaleimide, and N-phenylmaleimide are preferable.

Examples of monomers other than the maleimide used for the polymaleimide copolymer may be mentioned below.

For example, there may be mentioned acrylates, such as methyl acrylate, ethyl acrylate, vinyl acrylate, allyl acrylate, butyl acrylate, tert-butyl acrylate, isobutyl acrylate, isoamyl acrylate, hexyl acrylate, cyclohexyl acrylate, hydroxyethyl acrylate, 2-hydroxypropyl acrylate, 4-hydroxybutyl acrylate, 2-methoxyethyl acrylate, 2-methxoypropyl acrylate, 2-acetoxyethyl acrylate, 2-tetrahydroxyfurfuryl acrylate, glycidyl acrylate, 2,2,2-trifluoroethyl acrylate, 1,1,1,3,3,3-hexafluoropropyl acrylate, 2,2,3,3-tetrafluorpropyl acrylate, 3-(acryloyloxy) propyltrimethoxysilane, and 3-(acryloyloxy)propyltriethoxysilane; methacrylates, such as methyl methacrylate, ethyl methacrylate, a vinyl methacrylate, allyl methacrylate, butyl methacrylate, tert-butyl methacrylate, isobutyl methacrylate, isoamyl methacrylate, hexyl methacrylate, cyclohexyl methacrylate, hydroxyethyl methacrylate, 2-hydroxypropyl methacrylate, 4-hydroxybutyl methacrylate, 2-methoxyethyl methacrylate, 2-acetoxyethyl methacrylate, 2-methxoypropyl methacrylate, 2-tetrahydroxyfurfuryl methacrylate, glycidyl methacrylate, 2,2,2-trifluoriethyl methacrylate, 1,1,1,3,3,3-hexafluoropropyl methacrylate, 2,2,3,3-tetrafluorpropyl methacrylate, 3-(methacryloyloxy)propyltrimethoxysilane, and 3-(methacryloyloxy)propyltriethoxysilane; acrylamides, such as acrylamide, N-methylol acrylamide, N-methoxymethyl acrylamide, and N-butoxymethyl acrylamide; vinyl ethers, such as methyl vinyl ether, ethyl vinyl ether, n-propyl vinyl ether, isopropyl vinyl ether, n-butyl vinyl ether, tert-butyl vinyl ether, isobutyl vinyl ether, n-pentyl vinyl ether, n-hexyl vinyl ether, n-octyl vinyl ether, cyclohexyl vinyl ether, 2-hydroxyethyl vinyl ether, and 3-hydroxypropyl vinyl ether; and olefins, such as ethylene, isobutene, 1-pentene, 1-hexene, 1-octene, diisobutylene, 2-methyl-1-butent, 2-methyl-1-pentene, 2-methyl-1-hexene, 1-methyl-1-heptene, 1-isooctene, 2-methyl-1-octene, 2-ethyl-1-pentene, 2-methyl-2-butene, 2-methyl-2-pentene, and 2-methyl-2-hexene.

Those monomers may be used alone, or at least two types thereof may be used in combination. In view of polymerization properties, as a more suitable monomer copolymerizable with a maleimide, an acrylate and a methacrylate may be mentioned. Among those mentioned above, in view of polymer processability, refractive index, and adhesion, for example, methyl acrylate, 2,2,2-trifluoroethyl acrylate, 3-(acryloyloxy)propyltrimethoxysilane, methyl methacrylate, 2,2,2-trifluoroethyl methacrylate, and 3-(methacryloyloxy)propyltrimethoxysilane are more preferable.

As the polymerization initiator to be used, a radical polymerization initiator is preferable. Examples of the radical initiator will be mentioned below. For example, there may be mentioned organic peroxides, such as dibenzoyl peroxide, diisobutyloyl peroxide, bis(2,4-dichlorobenzoyl)peroxide, (3,5,5-trimethylhexanoyl)peroxide, dioctanoyl peroxide, dilauroyl peroxide, distearoyl peroxide, hydrogen peroxide, tert-butyl hydroperoxide, cumene hydroperoxide, p-menthane hydroperoxide, diisopropylbenzene hydroperoxide, 1,1,3,3-tetramethylbutyl hydroperoxide, tert-hexyl hydroperoxide, di-tert-butyl peroxide, dicumyl peroxide, dilauryl peroxide, α,α′-bis(tert-butylperoxy)diisopropylbenzene, 2,5-dimethyl-2,5-bis(tert-butylperoxy) hexane, tert-butylcumyl peroxide, 2,5-dimethyl-2,5-bis(tert-butylperoxy)hexane, tert-butylperoxy acetate, tert-butylperoxy pivalate, tert-hexylperoxy pivalate, 1,1,3,3-tetramethylbutylperoxy-2-ethylhexanoate, 2,5-dimethyl-2,5-bis(2-ethylhexanoylperoxy)hexane, 1-cyclohexyl-1-methylethylperoxy-2-ethylhexanoate, tert-hexylperoxy-2-ethylhexanoate, tert-butylperoxy-2-ethylhexanoate, tert-butylperoxy isobutylate, tert-butylperoxy maleate, tert-butylperoxy-3,5,5-trimethylhexanoate, tert-butylperoxy laurate, 2,5-dimethyl-2,5-bis(m-toluoylperoxy)hexane, α,α′-bis(neodecanoylperoxy)diisopropylbenzene, cumylperoxy neodecanoate, 1,1,3,3-tetramethylbutylperoxy neodecanoate, 1-cyclohexyl-1-methylethylperoxy neodecanoate, tert-hexylperoxy neododecanoate, tert-hexylperoxy neodecanoate, tert-butylperoxy benzoate, tert-hexylperoxy benzoate, bis(tert-butylperoxy)isophthalate, 2,5-dimethyl-2,5-bis(benzoylperoxy)hexane, tert-butylperoxy-m-toluoylbenzoate, 3,2′,4,4′-tetra(tert-butylperoxycarbonyl)benzophenone, 1,1-bis(tert-hexylperoxy)-3,3,5-trimethylcyclohexane, 1,1-bis(tert-hexylperoxy)cyclohexane, 1,1-bis(tert-butylperoxy)-3,3,5-trimethylcyclohexane, 1,1-bis(tert-butylperoxy)cyclohexane, 1,1-bis(tert-butylperoxy)cyclododecane, 2,2-bis(tert-butylperoxy)butane, n-butyl-4,4-bis(tert-butylperoxy)valerate, 2,2-bis(4,4-di-tert-butylperoxy cyclohexyl)propane, tert-hexylperoxy isopropyl carbonate, tert-butylperoxy isopropyl carbonate, tert-butylperoxy-2-ethylhexyl carbonate, tert-butylperoxy allyl carbonate, di-n-propylperoxy carbonate, diisopropylperoxy carbonate, bis(4-tert-butylcyclohexyl)peroxy carbonate, di-2-ethoxyethylperoxy carbonate, di-2-ethylhexylperoxy carbonate, di-2-methoxybutylperoxy carbonate, and di(3-methyl-3-methoxybutyl)peroxy carbonate; and azobis-based radical polymerization initiators, such as azobisisobutyronitrile, azobisisovaleronitrile, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2-(carbamoylazo)isobutylonitrile, 2,2′-azobis[2-methyl-N-[1,1-bis(hydroxymethyl)-2-hydroxyethyl]propionamide], 2,2′-azobis(2-methyl-N-(2-hydroxyethyl)propionamide), 2,2′,-azobis(N-(2-propenyl)2-methylpropionamide), 2,2′-azobis(N-butyl-2-methylpropioamide), 2,2′-azobis(N-cyclohexyl-2-methylpropioamide), 2,2′-azobis[2-(5-methyl-2-imidazolin-2-yl)propane]dihydrochloride, 2,2′-azobis[2-(2-imidazolin-2-yl)propane]dihydrochloride, 2,2′-azobis[2-(2-imidazolin-2-yl)propane]disulfide dihydrate, 2,2′-azobis[2-(3,4,5,6-tetrahydropyrimidine-2-yl)propane]dihydrochloride, 2,2′-azobis[2-[1-(2-hydroxyethyl)-2-imidazoline-2-yl]propane]dihydrochloride, 2,2′-azobis[2-(2-imidazoline-2-yl] propane], 2,2′-azobis(2-methylpropionamidine)dihydrochloride, 2,2′-azobis[N-(2-carboxyethyl)-2-methylpropionamidine], 2,2′-azobis(2-methylpropionamidoxime), dimethyl-2,2′-azobisbutylate, 4,4′-azobis(4cyanopentanoic acid), and 2,2-azobis(2,4,4-trimethylpentane).

The amount of those radical polymerization initiators with respect to 100 moles of the total monomer is preferably 0.0001 to 10 moles. When the amount of the radical polymerization initiator is less than 0.0001 moles, the polymerization reaction rate of the monomer is decreased, and the yield is decreased. On the other hand, when the amount is more than 10 moles, the molecular weight of the copolymer is decreased, and necessary characteristics may not be obtained in some cases. The amount is more preferably in a range of 0.001 to 5 moles.

Although known polymerization methods may be used for manufacturing the polymaleimide of the present invention or the copolymer thereof, a solution polymerization method is preferable. As a solvent used for the solution polymerization method, for example, methanol, isopropyl alcohol, isobutyl alcohol, 1-methoxy-2-propanaol, acetone, methyl ethyl ketone, methyl isobutyl ketone, cyclohexanone, ethyl acetate, butyl acetate, ethyl lactate, 1-methoxy-2-acetoxypropane, tetrahydrofuran, dioxane, butyl cellosolve, dimethylformamide, dimethyl sulfoxide, benzene, ethylbenzene, toluene, xylene, cyclohexane, ethyl cyclohexane, and acetonitrile may be mentioned. Those solvents may be used alone, or at least two types thereof may be used in combination. In addition, if necessary, those solvents may be dehydrated in advance before the use.

In addition, the content of the solvent with respect to 100 parts by mass of the total monomer is preferably 100 to 600 parts by mass. When the content of the solvent is less than 100 parts by mass, in some cases, the polymer may be precipitated, or stirring may become difficult to be performed due to a rapid increase in viscosity. When the content is more than 600 parts by mass, the molecular weight of an obtained copolymer may be decreased in some cases.

Although polymerization is performed after the above polymerization raw materials are charged in a reaction vessel, before the polymerization is performed, for example, vacuum degassing or nitrogen replacement is preferably performed so as to remove dissolved oxygen from the reaction system.

In addition, the polymerization temperature and the polymerization time must be determined in consideration of the reactivity of the monomer and that of the initiator. The polymerization temperature is preferably in a range of 50° C. to 200° C., and the polymerization time is preferably in a range of 1 to 100 hours. In consideration of easy polymerization control and the productivity, the polymerization temperature and the polymerization time are more preferably in a range of 50° C. to 100° C. and in a range of 1 to 50 hours, respectively.

As a preferable solvent used for the polymer solution containing the polymaleimide or the copolymer thereof, for example, there may be mentioned an acetic acid ester, such as ethyl acetate, butyl acetate, 1-methoxy-2-acetoxypropane, 2-methoxy ethyl acetate, or 2-ethoxy ethyl acetate; a formic acid ester, such as butyl formate, amyl formate, or hexyl formate; or a lactic acid ester, such as methyl lactate, ethyl lactate, or propyl lactate. The content of the total of those solvents is preferably 50 to 100 percent by mass of the total solvent. On the other hand, the content of cyclopentanone, cyclohexanone, and/or γ-butyrolactone is preferably 0 to less than 10 percent by mass of the total solvent.

In addition, besides the above solvents, for example, there may be mentioned ketones, such as 2-butanone and methyl isobutyl ketone; ethers, such as tetrahydrofuran, dioxane, and diisopropyl ether; various aromatic hydrocarbons, such as toluene, xylene, and ethylbenzene; chlorinated hydrocarbons, such as chloroform, methylene chloride, and tetrachloroethane; N-methylpyrrolidone, N,N-dimethylformamide, N,N-dimethylacetamide, dimethyl sulfoxide, and sulfolane. Furthermore, an alcohol, such as 1-butanol, methyl cellosolve, diglyme, or methoxypropanol, may also be used by mixing.

Although a component other than the polymaleimide or the copolymer thereof may be mixed with the polymer solution, the content of the component is preferably 0 to less than 20 percent by mass of the total nonvolatile component including the polymaleimide or the copolymer thereof. When the content is 20 percent by mass or more, the transparency, the film strength, and the uniformity of the film thickness are degraded. The content is more preferably 0 to less than 10 percent by mass. As the component other than the polymaleimide or the copolymer thereof, in order to improve the adhesion, a silane coupling agent or a phosphoric ester may be mentioned. In addition, for example, in order to suppress the coloring in a heat treatment, a phenolic antioxidant may also be added. In order to adjust the refractive index and to increase the film hardness, a small amount of inorganic particles, such as SiO₂, TiO₂, ZrO₂, ZnO, MgO, and/or Al₂O₃, may be added.

As a method for applying the polymer solution, an known coating method, such as a dipping method, a spin coating method, a spraying method, a printing method, a flow coating method, or a method in combination therebetween, may be appropriately used.

In the step of forming the second organic resin layer containing a polymaleimide or a copolymer thereof, an applied polymer solution is dried at 20° C. to 150° C. under normal pressure or reduced pressure. As a drying method performed while the applied polymer solution is left stand still or is rotated, air drying, drying using a hot-wind circulating oven or a muffle furnace, or drying by irradiation of light, such as infrared rays or microwaves, radiation rays, or electromagnetic rays, may be appropriately selected.

A method for manufacturing the layer having irregularities of the present invention preferably includes the following steps. First, a step of forming a layer containing aluminum oxide as a primary component is performed. Next, a step of drying and/or firing an applied aluminum oxide precursor sol at 50° C. to 250° C. to form an aluminum oxide film is performed. Furthermore, a step of immersing the above aluminum oxide film in hot water to form a layer having irregularities from a crystal containing aluminum oxide as a primary component is performed. The layer containing aluminum oxide as a primary component can be formed on the second organic resin layer 3, for example, by a known vapor phase method, such as CVD or PVD, a liquid phase method, such as a sol-gel method, or a hydrothermal synthesis using an inorganic salt. Since a uniform antireflection layer can be formed on a substrate having a large area or a nonplanar surface, a method is preferable in which a gel film formed by applying an aluminum oxide precursor sol containing aluminum oxide is processed by hot water to grow aluminum oxide crystals in the form of projections.

As a raw material of the gel film obtained from the aluminum oxide precursor sol, an aluminum compound is used with or without at least one type of compounds of Zr, Si, Ti, Zn, and Mg. As raw materials of Al₂O₃, ZrO₂, SiO₂, TiO₂, ZnO, and MgO, metal alkoxides, chlorides, and salts, such as nitrates, thereof may be used. In view of film formation properties, as raw materials of ZrO₂, SiO₂, and TiO₂, metal alkoxides thereof are preferably used.

As the aluminum compound, for example, there may be mentioned aluminum ethoxide, aluminum isopropoxide, aluminum-n-butoxide, aluminum-sec-butoxide, aluminum tert-butoxide, aluminum acetyl acetonate, oligomers of those mentioned above, aluminum nitrate, aluminum chloride, aluminum acetate, aluminum phosphate, aluminum sulfate, and aluminum hydroxide.

As particular examples of a zirconium alkoxide, for example, there may be mentioned zirconium tetramethoxide, zirconium tetraethoxide, zirconium tetra-n-propoxide, zirconium tetra-isopropoxide, zirconium tetra-n-butoxide, and zirconium tetra-t-butoxide.

As a silicon alkoxide, various types of compounds each represented by the general formula: Si(OR)₄ may be used. Rs′ each independently represent a lower alkyl group, such as a methyl group, an ethyl group, a propyl group, an isopropyl group, a butyl group, or an isobutyl group.

As a titanium alkoxide, for example, there may be mentioned tetramethoxytitanium, tetraethoxytitanium, tetra-n-propoxytitanium, tetraisopropoxytitanium, tetra-n-butoxytitanium, and tetraisobutoxytitanium.

As a zinc compound, for example, zinc acetate, zinc chloride, zinc nitrate, zinc stearate, zinc oleate, and zinc salicylate may be mentioned, and in particular, zinc acetate and zinc chloride are preferable.

As a magnesium compound, for example, there may be mentioned magnesium alkoxides, such as dimethoxymagnesium, diethoxymagnesium, dipropoxymagnesium, and dibutoxy magnesium, magnesium acetyl acetonate, and magnesium chloride.

As a preferable solvent for the aluminum oxide precursor sol, an alcohol having 3 to 7 carbon atoms, such as 2-propanal, 1-butanol, 2-butanol, isobutanol, 1-pentanol, 2-pentanol, 3-pentanol, cyclopentanol, 3-methyl-1-butanol, 4-methyl-2-pentanol, 2-ethyl-1-butanol, 2,4-dimethyl-3-pentanol, methyl cellosolve, ethyl cellosolve, propyl cellosolve, isopropyl cellosolve, butyl cellosolve, 1-methoxy-2-propanol, 1-ethoxy-2-propanol, 1-propoxy-2-propanol, 1-butoxy-2-propanol, and 3-methoxy-1-butanol may be mentioned by way of example, and the content of the total of those solvents is preferably 80 to 100 percent by mass of the total solvent.

As solvents other than those mentioned above, for example, methanol, ethanol, ethylene glycol, n-hexane, n-octane, cyclohexane, cyclopentane, cyclooctane, toluene, xylene, ethylbenzene, ethyl acetate, butyl acetate, 1-methoxy-2-acetoxy propane, 2-methoxyethyl acetate, 2-ethoxyethyl acetate, butyl formate, amyl formate, hexyl formate, methyl lactate, ethyl lactate, propyl lactate, acetone, methyl ethyl ketone, methyl isobutyl ketone, cyclohexanone, dimethoxyethane, tetrahydrofuran, dioxane, diisopropyl ether, chloroform, methylene chloride, carbon tetrachloride, tetrachloroethane, N-methylpyrrolidone, dimethylformamide, dimethylacetamide, and ethylene carbonate may be used by mixing.

When the alkoxide raw material is used, in particular, since alkoxides of aluminum, zirconium, and titanium have a high reactivity with water and are rapidly hydrolyzed by moisture in the air or by addition of water, cloudiness and/or precipitation is generated in the solution. In addition, since salt compounds of aluminum, zinc, and magnesium are difficult to be dissolved only by an organic solvent, the stability of the solution is low. In order to prevent those problems, the solution is preferably stabilized by addition of a stabilizer.

As the stabilizer, for example, there may be mentioned a β-diketone compound, such as acetyl acetone, dipivaloyl methane, trifluoroacetyl acetone, hexafluoroacetyl acetone, benzoyl acetone, dibenzoyl methane, 3-methyl-2,4-pentanedione, and 3-ethyl-2,4-pentanedione; and β-ketoester compounds, such as methyl acetoacetate, ethyl acetoacetate, allyl acetoacetate, benzyl acetoacetate, isopropyl acetoacetate, tert-butyl acetoacetate, iso-butyl acetoacetate, 2-methoxyethyl acetoacetate, and 3-keto-n-methyl valerate. Furthermore, for example, alkanolamines, such as monoethanolamine, diethanolamine, and triethanolamine, may also be mentioned. The addition amount of the stabilizer is preferably set to approximately one in terms of the molar ratio with respect to the alkoxide or the salt compound. In addition, after the addition of the stabilizer, in order to form an appropriate precursor, a catalyst is preferably added to promote part of the reaction. As the catalyst, for example, nitric acid, hydrochloric acid, sulfuric acid, phosphoric acid, acetic acid, or ammonia may be mentioned.

The aluminum oxide precursor sol can be applied to the surface of the second organic resin layer. As an application method, a known coating method, such as a dipping method, a spin coating method, a spraying method, a printing method, a flow coating method, or a method in combination therebetween, may be appropriately used.

When the applied aluminum oxide precursor sol film is dried and/or fired at 60° C. to 250° C., an aluminum oxide film can be formed. Although the density of the film can be increased as the heat treatment temperature is increased, when the heat treatment temperature is more than 250° C., damage, such as deformation of the substrate, may occur. The heat treatment temperature is more preferably 100° C. to 200° C. Although depending on the heating temperature, the heating time is preferably 10 minutes or more.

When the layer containing aluminum oxide as a primary component formed on the organic resin layer by the method described above is immersed in hot water or exposed to water vapor, an aluminum oxide crystal is precipitated, so that a surface layer having projections is formed. By the method as described above, in the layer having projections, an amorphous aluminum oxide layer may remain in a lower portion of each projection in some cases.

When the layer containing aluminum oxide as a primary component is immersed in hot water, the surface of the layer described above receives a peptization action, and some components thereof are dissolved out. By the difference in solubility between various types of hydroxides in hot water, a crystal containing aluminum oxide as a primary component is precipitated and grown to form a new surface layer. In addition, the temperature of the hot water is preferably set to 40° C. to 100° C. The hot-water treatment time is approximately 5 minutes to 24 hours.

At the surface of the layer containing aluminum oxide as a primary component to which oxides, such as TiO₂, ZrO₂, SiO₂, ZnO, and MgO, are added as foreign components, crystallization is performed using the difference in solubility to hot water between the components. Hence, unlike the case in which aluminum oxide is only used as the single component, when the composition of the inorganic components is changed, the size of the projection can be controlled over a wide range. As a result, the projection formed by the crystal can be controlled over the above wide range. Furthermore, when ZnO is used as an auxiliary component, since co-precipitation with aluminum oxide can be performed, the refractive index can also be controlled over a wide range, and as a result, excellent antireflection performance can be realized.

The step of forming the porous layer of the present invention preferably includes a substep of applying a silicon oxide particle sol and a substep of drying and/or firing the applied silicon oxide particle sol at 50° C. to 250° C. to form a porous layer of silicon oxide particles.

The silicon oxide particle sol contains a solvent and silicon oxide particles having a number average particle diameter of 1 to 100 nm. The silicon oxide particles preferably have voids and/or pores therein, and in this case, a porous layer having a lower refractive index can be obtained.

For the silicon oxide particle sol, a solvent similar to that for the aluminum oxide precursor sol may be used.

As a method for applying the silicon oxide particle sol, a method similar to that for applying the above polymer solution may also be used.

According to the present invention, an optical member having excellent optical characteristics and environmental reliability can be provided.

### EXAMPLES

Hereinafter, the present invention will be described in detail with reference to Examples. However, the present invention is not limited to the following Examples.

Evaluation of the optical members obtained in Examples and Comparative Examples, each of which had as a surface layer, fine irregularities (projections) containing crystals of aluminum oxide, were performed by the following method.

### (1) Synthesis of Polyimide and Preparation of Polyimide Solution 1

In N,N-dimethylacetamide (hereinafter abbreviated as “DMAc”) in an amount of 146.4 g, 16.6 g of 4,4′-bis(4-aminophenoxy)biphenyl and 1.3 g of 1,3-bis(3-aminopropyl)tetramethyldisiloxane were dissolved. While this diamine solution was stirred with water cooling, 13.0 g of 4-(2,5-dioxotetrahydrofuran-3-yl)-1,2,3,4-tetrahydronaphthalene-1,2-dicarboxylic anhydride was slowly added. This solution was stirred at room temperature for 15 hours to perform a polymerization reaction. Furthermore, after dilution was performed with 223.2 g of DMAc, 7.4 mL of pyridine and 3.8 mL of acetic acid anhydride were added, and stirring was performed at room temperature for 1 hour. Furthermore, while heating was performed at 60° C. to 70° C. using an oil bath, stirring was performed for 4 hours. After a polymerization solution was slowly charged into methanol which was vigorously stirred, a precipitated polymer was filtrated and was then cleaned in methanol several times with stirring. A polymer recovered by filtration was vacuum-dried at 80° C. to 90° C. As a result, 28.5 g (yield: 94%) of an aliphatic polyimide in a white powder form was obtained. The number average molecular weight was 25,100, and an imidization ratio of 99% was obtained from ¹H-NMR spectrum. The polyimide powder thus obtained was insoluble in 1-acetoxy-2-methoxypropane and butyl acetate.

The polyimide powder in an amount of 1.4 g was dissolved in 98.6 g of a mixed solvent containing cyclopentanone and cyclohexanone, so that a polyimide solution 1 containing a polyimide represented by the following formula (3) at a concentration of 2.1% was prepared.

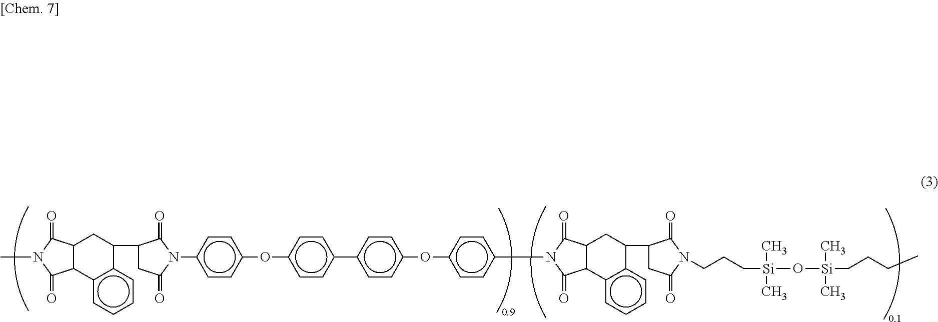

### (2) Preparation of Branched Melamine Polymer Solution 2

A photocurable paint of a branched melamine polymer (product name: Hypertech UR101, manufactured by Nissan Chemical Industries, Ltd.) having a repeating structure represented by the following general formula (4) was diluted with a mixed solvent containing cyclopentanone and cyclohexanone to a concentration of 2.9 percent by mass, so that a branched melamine polymer solution 2 was prepared.

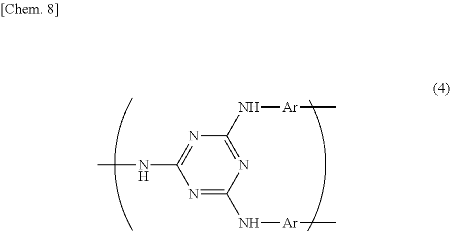

### (3) Preparation of Blend Polymer Solutions 3 and 4

The branched melamine polymer solution 2 in an amount of 50 g and the polyimide solution 1 in an amount of 54.2 g were mixed together at room temperature by stirring, so that a blend polymer solution 3 was prepared which had a blend ratio of 0.56/0.44 (weight ratio) of the branched melamine polymer to the polyimide.

Furthermore, part of the blend polymer solution 3 was diluted by 1.7 times with a mixed solvent containing cyclopentanone and cyclohexanone, so that a blend polymer solution 4 was prepared.

### (4) Preparation of Nano Zirconia Dispersion 5

After 1.5 g of a polystyrene powder (cross-linked with 1 percent by mole of divinyl benzene, manufactured by Tokyo Chemical Industry Co., Ltd.) was dissolved in 97.5 g of a cyclohexanone solution, 5.0 g of 20%-nano zirconia MEK dispersion (average particle diameter: 7 nm, manufactured by Sumitomo Osaka Cement Co., Ltd.) was added. MEK was removed by an evaporator, so that a nano zirconia dispersion 5 was prepared.

### (5) Synthesis of Polymaleimide and Preparation of Polymaleimide Solutions 6 and 7

In 25.8 g of toluene, 6.74 g of N-benzylmaleimide (hereinafter abbreviated as “BzMI”), 4.30 g of N-cyclohexylmaleimide, and 0.08 g of 2,2′-azobis(isobutylonitrile) (hereinafter abbreviated as “AIBN”) were dissolved with stirring. After degassing and nitrogen replacement of this solution were repeatedly performed while the solution was cooled with ice water, stirring was performed at 60° C. to 70° C. for 7 hours under a nitrogen gas flow. After a polymerization solution was slowly charged into methanol which was vigorously stirred, a precipitated polymer was filtrated and was then cleaned in methanol several times with stirring. A polymer recovered by filtration was vacuum-dried at 80° C. to 90° C. As a result, 10.2 g (yield: 92%) of a polymaleimide in a white powder form represented by the following formula (5) was obtained. The number average molecular weight obtained by a GPC measurement was 18,200. The synthetic results of individual polymers are shown in Table 1. From an IR spectrum, the absorption of the C═O stretching vibration of the imide ring and that of the C═O stretching vibration of the methacrylate unit were confirmed at 1,700 cm⁻¹ and 1,750 cm⁻¹, respectively. The polymaleimide powder thus obtained was insoluble in 1-methoxy-2-propanol and 1-pentanol.

The polymaleimide powder in an amount of 2.5 g was dissolved in 97.5 g of 1-acetoxy-2-methoxypropane, so that a polymaleimide solution 6 was prepared.

The polymaleimide powder in an amount of 4.5 g was dissolved in 95.5 g of ethyl lactate, so that a polymaleimide solution 7 was prepared.

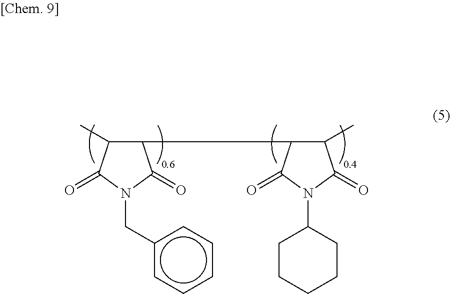

### (6) Synthesis of Poly(Maleimide-CO-Methacrylate) and Preparation of Poly(Maleimide-CO-Methacrylate) Solutions 8

Polymerization was performed using 9.55 g of BzMI, 0.90 g of methyl methacrylate, 0.08 g of AIBN, and 24.4 g of toluene by a method similar to that for the polymaleimide, and an obtained polymer was recovered. As a result, 9.5 g (yield: 90%) of a poly(maleimide-CO-methacrylate) in a white powder form represented by the following formula (6) was obtained. The number average molecular weight was 14,200. From an IR spectrum, the absorption of the C═O stretching vibration of the imide ring and that of the C═O stretching vibration of the methacrylate unit were confirmed at 1,690 cm⁻¹ and 1,750 cm⁻¹, respectively. The poly(maleimide-CO-methacrylate) powder thus obtained was insoluble in 1-methoxy-2-propanol and 1-pentanol.

In 97.5 g of 1-acetoxy-2-methoxypropane, 2.5 g of the poly(maleimide-CO-methacrylate) powder was dissolved, so that a poly(maleimide-CO-methacrylate) solution 8 was prepared.

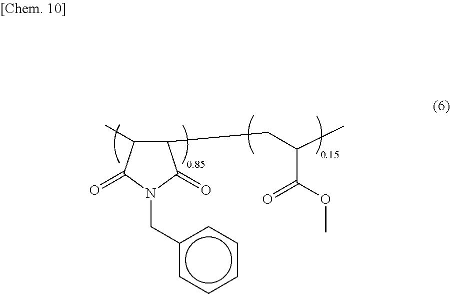

### (7) Preparation of Polystyrene Solutions 9 and 10

In 97.5 g of 1-acetoxy-2-methoxypropane, 2.5 g of a commercially available polystyrene powder (weight average molecular weight: 20,000, manufactured by Fulka) was dissolved, so that a polystyrene solution 9 was prepared.

In 95.5 g of 1-acetoxy-2-methoxypropane, 4.5 g of a commercially available polystyrene powder (weight average molecular weight: 20,000, manufactured by Fulka) was dissolved, so that a polystyrene solution 10 was prepared.

### (8) Preparation of Aluminum Oxide Precursor Sols 11 and 12

Aluminum-sec-butoxide (ASBD, manufactured by Kawaken Fine Chemicals Co., Ltd.) in an amount of 14.8 g, 3.42 g of 3-methyl-2,4-pentadion and 2-ethylbutanol were mixed together by stirring until a uniform solution was obtained. After 1.94 g of 0.01 M diluted hydrochloric acid was dissolved in a mixed solvent containing 2-ethylbutanol and 1-ethoxy-2-propanol, the aluminum-sec-butoxide solution was slowly added and then stirred for some time. Adjustment was performed so as to finally obtain a mixed solvent containing 36.9 g of 2-ethylbutanol and 15.8 g of 1-ethoxy-2-propanal. Furthermore, stirring was preformed using an oil bath at 120° C. for 3 hours or more, so that an aluminum oxide precursor sol 11 was prepared. The average particle diameter measured by a dynamic light scattering method was 10 nm.

The aluminum oxide precursor sol 11 was diluted by 7 times with a mixed solvent containing 2-ethylbutanol and 1-ethoxy-2-propanol, so that an aluminum oxide precursor sol 12 was prepared.

### (9) Preparation of Silicon Oxide Particle Sol 13

After 96.2 g of 2-methoxypropanol was added to 19.0 g of an IPA sol of 20%-silicon oxide hollow particles (Throughrear 1011, manufactured by JGC Catalysts and Chemicals Ltd.), IPA was removed by an evaporator, so that a silicon oxide particle sol 13 was prepared.

### (10) Molecular Weight Measurement

Two Shodex LF-804 columns (manufactured by Showa Denko K.K.) were arranged in series in a gel permeation chromatography (GPC) apparatus (manufactured by Waters Corp.), and measurement was performed at 40° C. using THF as an eluent by a refractive index (RI, differential refractive index) detector. The obtained number average molecular weight was represented by a standard polystyrene conversion value.

### (11) Measurement of Infrared Transmission Spectrum of Polymer Powder

By an infrared spectroscopic measurement apparatus (Spectrum One, manufactured by Perkin Elmer) and attached universal ATR, an infrared transmission spectrum in a range of 650 cm⁻¹ to 4,000 cm⁻¹ was measured.

### (12) Measurement of Average Particle Diameter

Approximately 1 mL of the aluminum oxide precursor sol was placed in a glass cell, and measurement was performed at 25° C. using a particle size distribution analyzer (Zetasizer Nano S, manufactured by Malvern Instruments Ltd.). Analysis was performed using a sol viscosity measured in advance using a refractive index of 1.5 and an absorption rate of 0.01. From the maximum value of the particle size distribution curve (particle size-scattering intensity), the average particle diameter was obtained. The viscosity used for the analysis was measured at 25° C. using a rotary viscometer (RE80 type viscometer, manufactured by Toki Sangyo Co., Ltd.) equipped with a standard rotor (1° 34′, R24).

### (13) Cleaning of Substrate

After a glass substrate which had a diameter of approximately 30 mm and a thickness of approximately 5 mm, the two surfaces of which were polished, was cleaned in an alkaline detergent by ultrasonic cleaning and was then rinsed with pure water, drying was performed in a clean oven at 60° C. for 30 minutes.

### (14) Reflectance Measurement

By the use of an absolute reflectance measurement apparatus (USPM-RU, manufactured by Olympus Corp.), reflectance measurement was performed at an incident angle of 0° in a range of 400 to 700 nm. A minimum value of less than 0.05% was evaluated as ◯, and a minimum value of 0.05% or more was evaluated as x. An average value of less than 0.1% was evaluated as ◯, an average value of 0.1% to less than 0.2% was evaluated as Δ, and an average value of 0.2% or more was evaluated as x.

### (15) Transmission Observation

Light from a slide projector was allowed to pass through a film, and visual inspection was performed to check whether the film was clouded or not. The case in which the film was not clouded was evaluated as ◯, and the case in which the film was clouded was evaluated as x.

### (16) Measurement of Film Thickness

Measurement was performed using a spectroscopic ellipsometer (VASE, manufactured by J.A. Woollam Japan Co., Inc.) at a wavelength of 380 to 800 nm, and the film thickness was obtained by the analysis.

### (17) Measurement of Refractive Index

Measurement was performed using a spectroscopic ellipsometer (VASE, manufactured by J.A. Woollam Japan Co., Inc.) at a wavelength of 380 to 800 nm. A refractive index at a wavelength of 550 nm was used as the refractive index.

### (18) Observation of Substrate Surface

After a Pd/Pt treatment was performed on a substrate surface, the substrate surface was observed using a field emission scanning electron microscope (FE-SEM, S-4800, manufactured by Hitachi High-Technologies Corp.) at an accelerating voltage of 2 kV.

### Example 1

An appropriate amount of the polyimide solution 1 was dripped on a cleaned glass substrate containing La₂O₃ as a primary component and having an nd of 1.72 and a νd of 50, and spin coating was further performed at 4,500 rpm for 20 seconds. This substrate was heated at 100° C. for 20 minutes, so that a substrate was formed which was provided with a polyimide film having a film thickness of 25 nm and a refractive index of 1.671 at a wavelength of 550 nm.

An appropriate amount of the polymaleimide solution 6 was dripped on the polyimide film, and spin coating was further performed at 4,500 rpm for 20 seconds. This substrate was heated at 100° C. for 20 minutes, so that a polymaleimide film having a film thickness of 25 nm and a refractive index of 1.565 at a wavelength of 550 nm was formed on the polyimide film.

An appropriate amount of the aluminum oxide precursor sol 11 was dripped on the polymaleimide film, and spin coating was performed at 3,000 rpm for 20 seconds. Heating was performed at 140° C. for 60 minutes, so that an amorphous aluminum oxide film having a film thickness of 150 nm was formed on the polymaleimide film.

Next, after the substrate was immersed in hot water at 80° C. for 20 minutes, drying was performed at 60° C. for 15 minutes. When the surface and the cross-sectional surface of the substrate thus processed was observed by a FE-SEM, a texture having fine projections in which plate crystals containing aluminum oxide as a primary component were randomly grown was observed, and the thickness of the layer having projections was approximately 250 nm.

Next, the absolute reflectance of the substrate surface was measured, and a glass substrate provided with an excellent antireflection film was obtained in which the maximum value and the average value of the absolute reflectance shown in FIG. 6 were 0.08% and 0.025%, respectively. In addition, even when the substrate was left for 1,000 hours under high-temperature and high-humidity conditions at 60° C. and 100% RH, the change in absolute reflectance was less than 0.05%. The results of Examples and Comparative Examples are shown in Table 1.

TABLE 1

| | | | | | | | | | | | | Change in |
|---|---|---|---|---|---|---|---|---|---|---|---|---|
| | | | | | | | | | | | | absolute |
| | | | | | | | | | | | | reflectance |
| | | First organic resin layer | | | Second organic resin layer | | | | | Absolute | | under high- |
| | | | Film | Refrac- | | Film | Refrac- | | | reflectance % | | temperature |
| | | | thick- | tive | | thick- | tive | Surface layer | | 400 to 700 nm | | and high- |
| | Type of | | ness | index at | | ness | index at | | Thick- | Maximum | Average | humidity |
| | substrate | Type | nm | 550 nm | Type | nm | 550 nm | Type | ness | value | value | conditions |
| Example 1 | La₂O₃ | Polyimide | 25 | 1.671 | polymale- | 25 | 1.565 | Aluminum | About | ⊙0.080 | ⊙0.025 | ◯ < 0.05 |
| | nd = 1.72 | | | | imide | | | oxide with | 250 nm | | | |
| | | | | | | | | uneven | | | | |
| | | | | | | | | structure | | | | |
| Example 2 | La₂O₃ | Blend | 45 | 1.756 | polymale- | 22 | 1.564 | Aluminum | About | ⊙0.079 | ⊙0.030 | ◯ < 0.05 |
| | nd = 1.83 | polymer | | | imide | | | oxide with | 250 nm | | | |
| | | | | | | | | uneven | | | | |
| | | | | | | | | structure | | | | |
| Example 3 | La₂O₃ | Blend | 45 | 1.756 | Poly(male- | 22 | 1.563 | Aluminum | About | ⊙0.062 | ⊙0.031 | ◯ < 0.05 |
| | nd = 1.83 | polymer | | | imide-CO- | | | oxide with | 250 nm | | | |
| | | | | | methacrylate) | | | uneven | | | | |
| | | | | | | | | structure | | | | |
| Example 4 | TiO₂ | Blend | 45 | 1.756 | polymale- | 22 | 1.564 | Aluminum | About | ⊙0.086 | ⊙0.034 | ◯ < 0.05 |
| | nd = 1.85 | polymer | | | imide | | | oxide with | 250 nm | | | |
| | | | | | | | | uneven | | | | |
| | | | | | | | | structure | | | | |
| Example 5 | La₂O₃ | Branched | 60 | 1.815 | polymale- | 22 | 1.564 | Aluminum | About | ⊙0.048 | ⊙0.025 | ◯ < 0.05 |
| | nd = 2.00 | melamine | | | imide | | | oxide with | 250 nm | | | |
| | | polymer | | | | | | uneven | | | | |
| | | | | | | | | structure | | | | |
| Comparative | La₂O₃ | Blend | 45 | 1.756 | porous | 23 | 1.554 | Aluminum | About | Δ0.235 | ⊙0.047 | X > 0.1 |
| Example 1 | nd = 1.83 | polymer | | | aluminum | | | oxide with | 250 nm | | | |
| | | | | | oxide | | | uneven | | | | |
| | | | | | | | | structure | | | | |
| Comparative | La₂O₃ | Blend | 45 | 1.756 | polysty- | 22▾ | 1.595 | Aluminum | About | ◯0.186 | Δ0.143 | X > 0.1 |
| Example 2 | nd = 1.83 | polymer | | | rene | | | oxide with | 250 nm | | | |
| | | | | | | | | uneven | | | | |
| | | | | | | | | structure | | | | |
| Comparative | La₂O₃ | Nano | 46▾ | 1.745 | polymale- | 22 | 1.564 | Aluminum | About | ◯0.179 | Δ0.123 | X > 0.1 |
| Example 3 | nd = 1.83 | zirconia | | | imide | | | oxide with | 250 nm | | | |
| | | dispersion | | | | | | uneven | | | | |
| | | film | | | | | | structure | | | | |
| Comparative | La₂O₃ | — | — | — | polymale- | 35 | 1.570 | Aluminum | About | Δ0.354 | Δ0.125 | X > 0.1 |
| Example 4 | nd = 1.83 | | | | imide | | | oxide with | 250 nm | | | |
| | | | | | | | | uneven | | | | |
| | | | | | | | | structure | | | | |
| Example 6 | La₂O₃ | Blend | 26 | 1.750 | polymale- | 70 | 1.580 | Porous | 103 nm | ◯0.178 | ◯0.057 | ◯ < 0.05 |
| | nd = 1.83 | polymer | | | imide | | | silicon | | | | |
| | | | | | | | | oxide | | | | |
| | | | | | | | | particles | | | | |
| Comparative | La₂O₃ | Blend | 26 | 1.75 | polysty- | 70▾ | 1.600 | Porous | 103 nm | X1.401 | X0.478 | X > 0.2 |
| Example 5 | nd = 1.83 | polymer | | | rene | | | silicon | | | | |
| | | | | | | | | oxide | | | | |
| | | | | | | | | particles | | | | |
| Comparative | La₂O₃ | — | — | — | polymale- | 70 | 1.580 | Porous | 104 nm | Δ0.343 | Δ0.111 | X > 0.2 |
| Example 6 | nd = 1.83 | | | | imide | | | silicon | | | | |
| | | | | | | | | oxide | | | | |
| | | | | | | | | particles | | | | |

In Table 1, the second organic resin layer of Comparative Example 1 was a porous aluminum oxide film, that is, an inorganic film. In addition, the mark “▾” shown in the column of the film thickness indicates that the film was dissolved out when the upper layer was applied.

The evaluation of the absolute reflectance was performed using the following criteria.

For evaluation of the maximum value of the absolute reflectance, 0.1% or less, 0.2% or less, 0.5% or less, and more than 0.5% were evaluated as ⊙, ◯, Δ, and x, respectively. For evaluation of the average value of the absolute reflectance, 0.05% or less, 0.1% or less, 0.2% or less, and more than 0.2% were evaluated as ⊙, ◯, Δ, and x, respectively.

For evaluation of the change in absolute reflectance under high-temperature and high-humidity conditions, 0.05% or less, 0.1% or less, and more than 0.1% were evaluated as ◯, Δ, and x, respectively.

### Example 2

An appropriate amount of the polymer blend solution 3 was dripped on a cleaned glass substrate containing La₂O₃ as a primary component and having an nd of 1.83 and a νd of 43, and spin coating was further performed at 4,500 rpm for 20 seconds. This substrate was heated at 100° C. for 20 minutes, so that a substrate was formed which was provided with a blend polymer film having a film thickness of 45 nm and a refractive index of 1.756 at a wavelength of 550 nm.

An appropriate amount of the polymaleimide solution 6 was dripped on the blend polymer film, and spin coating was further performed at 5,000 rpm for 20 seconds. This substrate was heated at 100° C. for 20 minutes, so that a polymaleimide film having a film thickness of 22 nm and a refractive index of 1.564 at a wavelength of 550 nm was formed on the blend polymer film.

By a method similar to that of Example 1, a texture having fine projections which contained aluminum oxide as a primary component was formed on the surface of the polymaleimide film, so that a substrate provided with an antireflection film was formed.

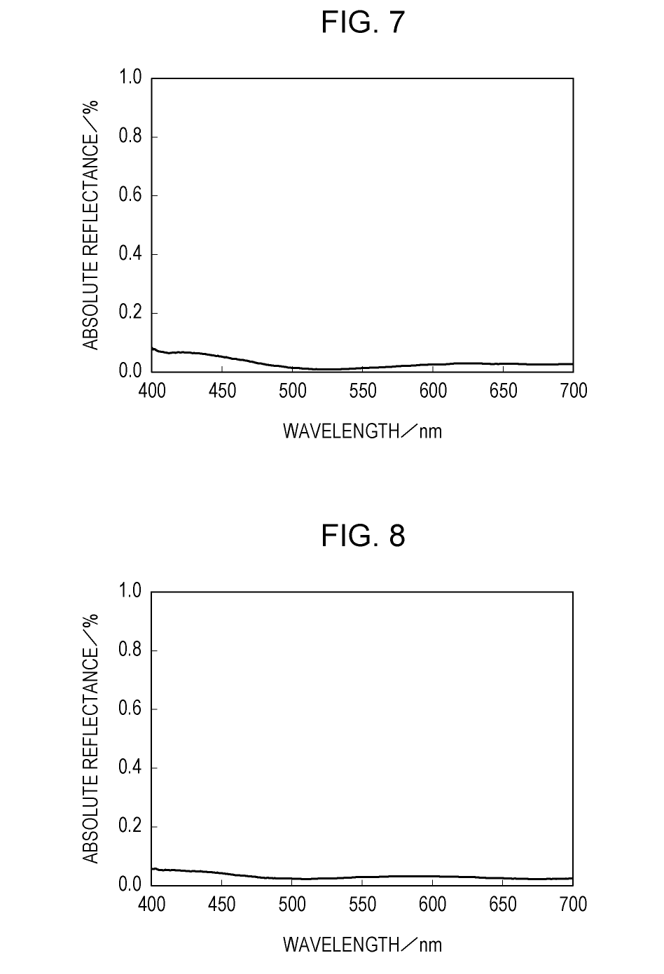

A glass substrate provided with an excellent antireflection film having a maximum absolute reflectance of 0.079% and an average absolute reflectance of 0.030% was obtained after the texture having fine projections was formed (FIG. 7). In addition, even if the above substrate was left for 1,000 hours under high-temperature and high-humidity conditions at 60° C. and 100% RH, the change in absolute reflectance was less than 0.05%.

### Example 3

Except that the polymaleimide solution was changed to the poly(maleimide-CO-methacrylate) solution 8, a substrate provided with an antireflection film was formed by a method similar to that of Example 2. The poly(maleimide-CO-methacrylate) film had a thickness of 22 nm and a refractive index of 1.563 at a wavelength of 550 nm.

A glass substrate provided with an excellent antireflection film having a maximum absolute reflectance of 0.062% and an average absolute reflectance of 0.031% was obtained (FIG. 8). In addition, even if the above substrate was left for 1,000 hours under high-temperature and high-humidity conditions at 60° C. and 100% RH, the change in absolute reflectance was less than 0.05%.

### Example 4

Except that the glass substrate was changed to a glass substrate containing TiO₂ as a primary component and having an nd of 1.85 and a νd of 24, a substrate provided with an antireflection film was formed by a method similar to that of Example 2.

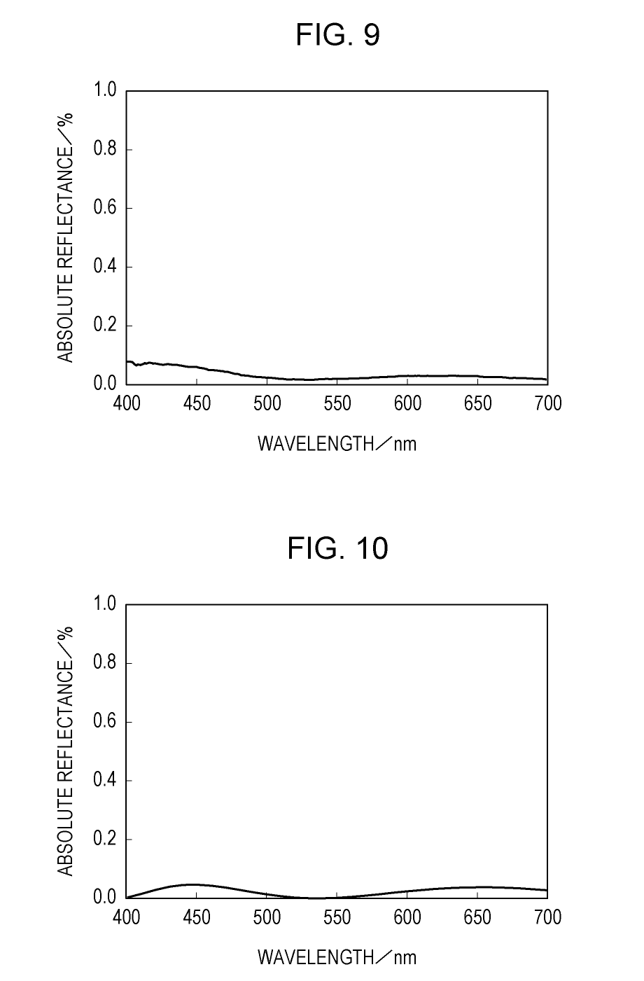

A glass substrate provided with an excellent antireflection film having a maximum absolute reflectance of 0.086% and an average absolute reflectance of 0.034% was obtained (FIG. 9) after the texture having fine projections was formed. In addition, even if the above substrate was left for 1,000 hours under high-temperature and high-humidity conditions at 60° C. and 100% RH, the change in absolute reflectance was less than 0.05%, and cloudiness was not generated.

### Example 5

The glass substrate was changed to a glass substrate containing La₂O₃ as a primary component and having an nd of 2.00 and a νd of 28, an appropriate amount of the branched melamine polymer solution 2 was dripped instead of using the blend polymer solution 3, and spin coating was further performed at 2,500 rpm for 20 seconds. This substrate was heated at 100° C. for 20 minutes, so that a substrate was formed which was provided with a branched melamine polymer film having a thickness of 60 nm and a refractive index of 1.815 at a wavelength of 550 nm.

By a method similar to that of Example 2, there was obtained a substrate provided with an antireflection film in which on the branched melamine polymer film, a polymaleimide film and a texture having fine projections containing aluminum oxide as a primary component were formed in this order.

A glass substrate provided with an excellent antireflection film having a maximum absolute reflectance of 0.048% and an average absolute reflectance of 0.025% was obtained (FIG. 10) after the texture having fine projections was formed. In addition, even if the above substrate was left for 1,000 hours under high-temperature and high-humidity conditions at 60° C. and 100% RH, the change in absolute reflectance was less than 0.05%.

### Comparative Example 1

An appropriate amount of the blend polymer solution 3 was dripped on a cleaned glass substrate containing La₂O₃ as a primary component and having an nd of 1.83 and a νd of 43, and spin coating was further performed at 4,500 rpm for 20 seconds. This substrate was heated at 100° C. for 20 minutes, so that a substrate was formed which was provided with a blend polymer film having a film thickness of 45 nm and a refractive index of 1.756 at a wavelength of 550 nm.

An appropriate amount of the aluminum oxide precursor sol 12 was dripped on the blend polymer film, and spin coating was further performed at 4,500 rpm for 20 seconds. After this substrate was heated at 200° C. for 60 minutes, wet heating was performed at 80° C. and 70% RH for 120 minutes, so that a porous aluminum oxide film having a film thickness of 23 nm and a refractive index of 1.544 at a wavelength of 550 nm was formed on the blend polymer film.

By a method similar to that of Example 1, a substrate provided with an antireflection film was formed by forming on the surface of the porous aluminum oxide film, a texture having fine projections which contained aluminum oxide as a primary component.

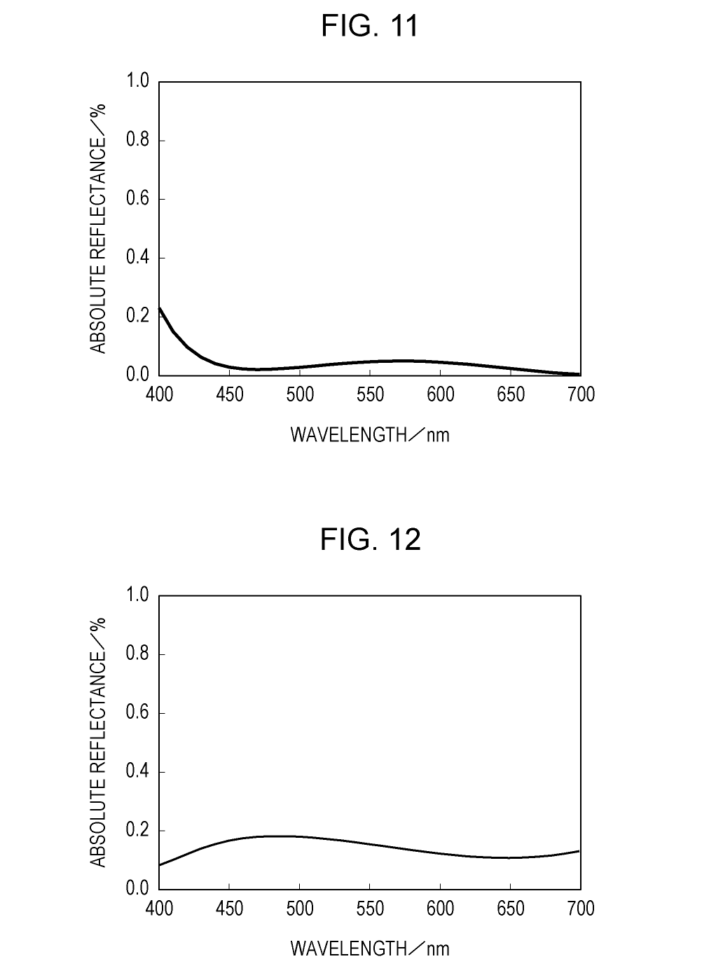

A glass substrate provided with an antireflection film having a maximum absolute reflectance of 0.235% and an average absolute reflectance of 0.047% was obtained (FIG. 11) after the texture having fine projections was formed. In addition, when the above substrate was left for 1,000 hours under high-temperature and high-humidity conditions at 60° C. and 100% RH, a change in absolute reflectance of up to more than 0.1% was observed. The reason for this is believed that the thickness and the refractive index of the porous aluminum oxide film are changed by moisture and/or humidity.

### Comparative Example 2

Except that the polymaleimide solution 6 was changed to the polystyrene solution 9, a substrate provided with an antireflection film was formed by a method similar to that of Example 2. Although the polystyrene film had a thickness of 22 nm and a refractive index 1.595 at a wavelength of 550 nm, when the aluminum oxide precursor sol 11 was applied to the polystyrene film, the polystyrene film was partially dissolved, and the thickness thereof was decreased to approximately 10 nm.

A glass substrate provided with an antireflection film having a maximum absolute reflectance of 0.186% and an average absolute reflectance of 0.143% was obtained (FIG. 12) after the texture having fine projections was formed. In addition, when the above substrate was left for 1,000 hours under high-temperature and high-humidity conditions at 60° C. and 100% RH, a change in absolute reflectance of up to more than 0.1% was observed.

### Comparative Example 3

Except that the blend polymer solution 3 was changed to the nano zirconium dispersion 5, a substrate provided with an antireflection film was formed by a method similar to that of Example 2. Although the nano zirconium dispersion film had a thickness of 46 nm and a refractive index 1.745 at a wavelength of 550 nm, when the polymaleimide solution 6 was applied to the nano zirconium dispersion film, the nano zirconium dispersion film was partially dissolved, and the thickness thereof was decreased to approximately 20 nm.

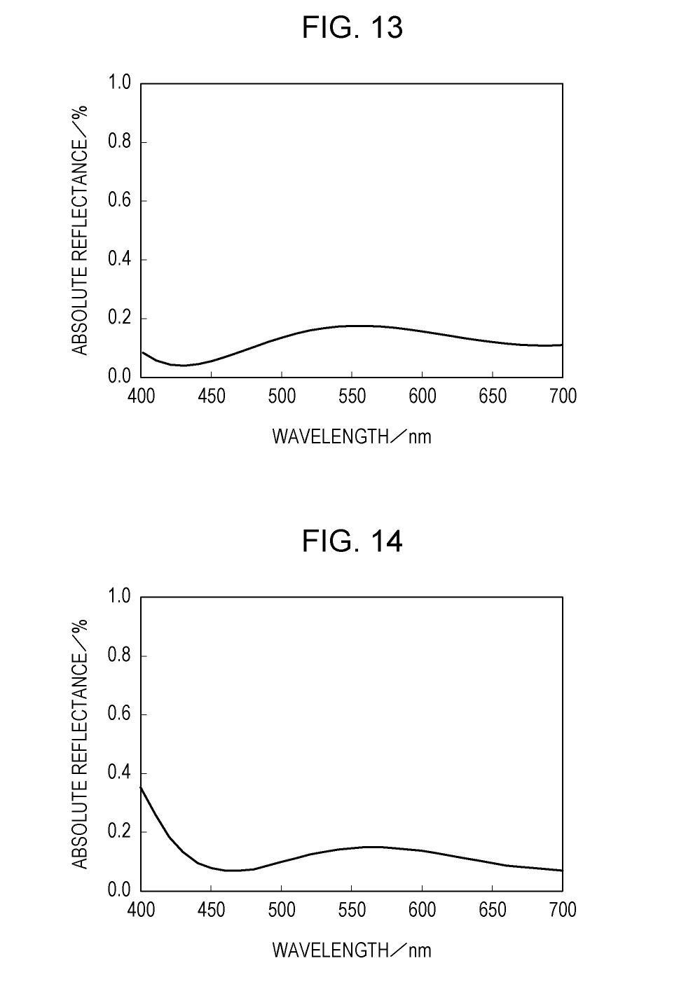

A glass substrate provided with an antireflection film having a maximum absolute reflectance of 0.179% and an average absolute reflectance of 0.123% was obtained (FIG. 13) after the texture having fine projections was formed. In addition, when the above substrate was left for 1,000 hours under high-temperature and high-humidity conditions at 60° C. and 100% RH, a change in absolute reflectance of up to more than 0.1% was observed.

### Comparative Example 4

An appropriate amount of the polymaleimide solution 6 was dripped on a cleaned glass substrate containing La₂O₃ as a primary component and having an nd of 1.83 and a νd of 43, and spin coating was further performed at 2,000 rpm for 20 seconds. This substrate was heated at 100° C. for 20 minutes, so that a substrate was formed which was provided with a polymaleimide film having a film thickness of 35 nm and a refractive index of 1.570 at a wavelength of 550 nm.

By a method similar to that of Example 1, a substrate provided with an antireflection film was formed by forming on the surface of the polymaleimide film, a texture having fine projections which contained aluminum oxide as a primary component.

A glass substrate provided with an antireflection film having a maximum absolute reflectance of 0.354% and an average absolute reflectance of 0.125% was obtained (FIG. 14) after the texture having fine projections was formed. In addition, when the above substrate was left for 1,000 hours under high-temperature and high-humidity conditions at 60° C. and 100% RH, a change in absolute reflectance of up to more than 0.1% was observed. The reason for this is believed that the thickness and the refractive index of the porous aluminum oxide film are changed by moisture and/or humidity.

### Example 6

An appropriate amount of the blend polymer solution 4 was dripped on a cleaned glass substrate containing La₂O₃ as a primary component and having an nd of 1.83 and a νd of 43, and spin coating was further performed at 6,000 rpm for 20 seconds. This substrate was heated at 100° C. for 20 minutes, so that a substrate was formed which was provided with a blend polymer film having a film thickness of 26 nm and a refractive index of 1.750 at a wavelength of 550 nm.

An appropriate amount of the polymaleimide solution 7 was dripped on the blend polymer film, and spin coating was further performed at 4,500 rpm for 20 seconds. This substrate was heated at 100° C. for 20 minutes, so that a polymaleimide film having a film thickness of 70 nm and a refractive index of 1.580 at a wavelength of 550 nm was formed on the blend polymer film.

An appropriate amount of the silicon oxide particle sol 13 was dripped on the polymaleimide film, and spin coating was performed at 4,500 rpm for 20 seconds. Heating was performed at 140° C. for 60 minutes, so that a film having a thickness of 103 nm and a refractive index of 1.20 at a wavelength of 550 nm was formed from silicon dioxide particles deposited on the polymaleimide film.

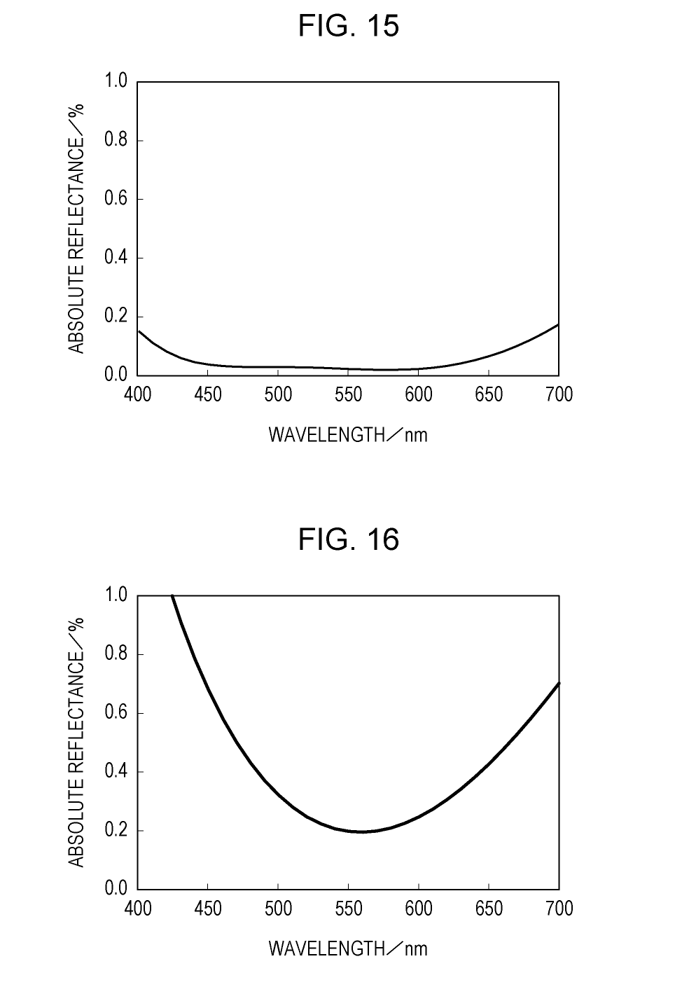

Next, the absolute reflectance of the surface of the substrate was measured, and a glass substrate provided with an excellent antireflection film having a maximum absolute reflectance of 0.178% and an average absolute reflectance of 0.057% was obtained (FIG. 15). In addition, even when the above substrate was left for 1,000 hours under high-temperature and high-humidity conditions at 60° C. and 100% RH, the change in absolute reflectance was less than 0.05%.

### Comparative Example 5

Except that the polymaleimide solution 7 was changed to the polystyrene solution 10, a substrate provided with an antireflection film was formed by a method similar to that of Example 6. Although the polystyrene film had a thickness of 70 nm and a refractive index 1.600 at a wavelength of 550 nm, when the silicon oxide particle sol 13 was applied to the polystyrene film, the polystyrene film was partially dissolved, and the thickness thereof was decreased to approximately 45 nm.

A glass substrate provided with an antireflection film having a maximum absolute reflectance of 1.401% and an average absolute reflectance of 0.478% was obtained (FIG. 16) after the film of silicon oxide particles thus deposited was formed. In addition, when the above substrate was left for 1,000 hours under high-temperature and high-humidity conditions at 60° C. and 100% RH, a change in absolute reflectance of up to more than 0.2% was observed.

### Comparative Example 6

An appropriate amount of the polymaleimide solution 7 was dripped on a cleaned glass substrate containing La₂O₃ as a primary component and having an nd of 1.83 and a νd of 43, and spin coating was further performed at 4,500 rpm for 20 seconds. This substrate was heated at 100° C. for 20 minutes, so that a substrate provided with a polymaleimide film having a film thickness of 70 nm and a refractive index of 1.580 at a wavelength of 550 nm was formed. By a method similar to that of Example 6 except for the steps described above, a film was formed from silicon oxide particles deposited on the polymaleimide film.

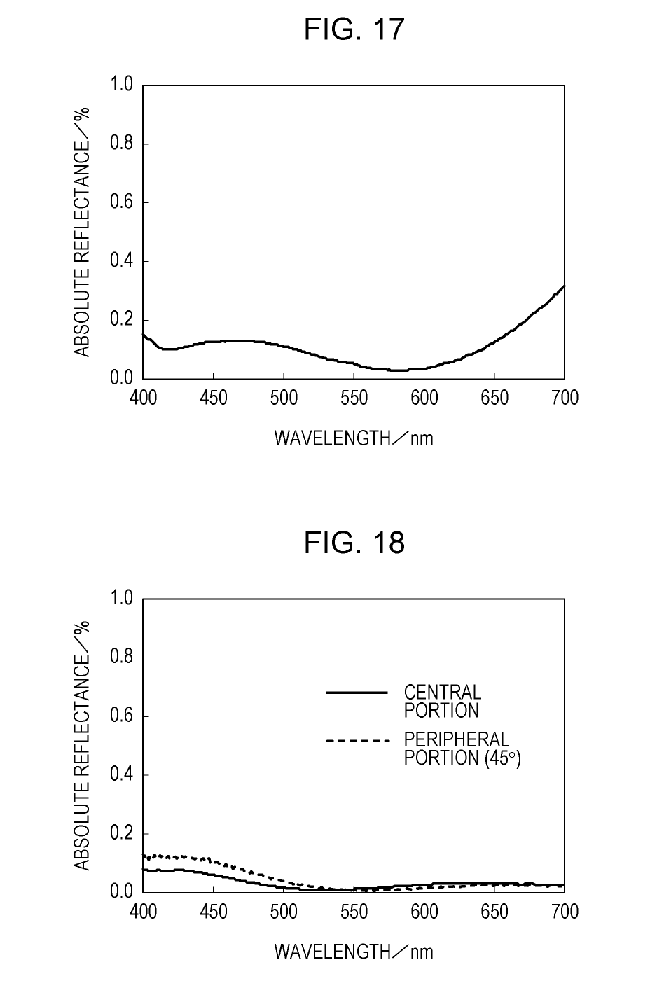

A glass substrate provided with an antireflection film having a maximum absolute reflectance of 0.343% and an average absolute reflectance of 0.111% was obtained (FIG. 17) after the film of silicon oxide particles thus deposited was formed. In addition, when the above substrate was left for 1,000 hours under high-temperature and high-humidity conditions at 60° C. and 100% RH, a change in absolute reflectance of up to more than 0.2% was observed.

### Example 7

A texture having fine projections which contained aluminum oxide as a primary component was formed on a concave surface (diameter: 45 mm, curvature radius: 27 mm) of a lens formed of a glass containing La₂O₃ as a primary component and having an nd of 1.83 and a νd of 43 by a method similar to that of Example 2.

According to the lens provided with the antireflection film thus formed, the maximum value and the average value of the absolute reflectance at a central portion of the surface on which the texture having projections was formed were 0.081% and 0.034%, respectively, and the maximum value and the average value of the absolute reflectance at a peripheral portion at a half-opening portion of 45° were 0.132% and 0.045%, respectively. Hence, a lens was obtained which was covered with an excellent antireflection film from the central portion to the peripheral portion thereof (FIG. 18), the performance of the film being equivalent to that provided on a glass substrate. Even when the glass substrate was left for 1,000 hours under high-temperature and high-humidity conditions at 60° C. and 100% RH, the change in absolute reflectance was not more then 0.05%.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-245198, filed Nov. 27, 2013, which is hereby incorporated by reference herein in its entirety.

### REFERENCE SIGNS LIST

1 substrate
2 first organic resin layer
3 second organic resin layer
4 porous layer
5 layer having irregularities (projections)
6 irregularities (projections)
7 tilting angle of projection
8 tilting angle of projection
9 tangent line of substrate surface

1. An optical member comprising:
a substrate; and
a laminated body formed on a surface of the substrate,
wherein the laminated body includes:
a porous layer or a layer having an uneven structure as a surface layer;
a first organic resin layer containing a polymer having an aromatic ring and/or an imide ring in its main chain as a primary component; and
a second organic resin layer containing a polymaleimide having a repeating unit represented by general formula (1) or a copolymer thereof as a primary component, the first organic resin layer and the second organic resin layer being provided in this order from the substrate to the surface layer 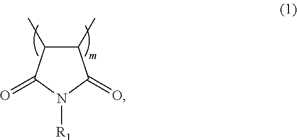
wherein in formula (1), R₁ represents a linear, a branched, or a cyclic alkyl or alkenyl group having a 1 to 8 carbon atoms which is unsubstituted or substituted by a phenyl group, a hydroxy group, an alkoxy group, an acetoxy group, a cyclic ether group, an amino group, an alkoxysilyl group, and/or a halogen atom, or a phenyl, a biphenyl, or a naphthyl group which is unsubstituted or substituted by an alkyl group, an alkenyl group, an alkoxy group, an acetoxy group, an alkoxysilyl group, a nitro group, and/or a halogen group, and m is an integer of 1 or more.

2. The optical member according to claim 1,
wherein the polymer having an aromatic ring and/or an imide ring in its main chain of the first organic resin layer is soluble in at least one type of solvent selected from cyclohexanone, cyclopentanone, and γ-butyrolactone and is insoluble in at least one type of solvent selected from acetic acid esters and lactic acid esters.

3. The optical member according to claim 1,
wherein the polymaleimide or the copolymer thereof of the second organic resin layer is soluble in at least one type of solvent selected from acetic acid esters and lactic acid esters and is insoluble in at least one type of solvent selected from alcohols having 3 to 7 carbon atoms.

4. The optical member according to claim 1,
wherein the polymer having an aromatic ring and/or an imide ring in its main chain of the first organic resin layer includes a branched melamine polymer.

5. The optical member according to claim 4,
wherein the branched melamine polymer contains a repeating structure represented by general formula (2) 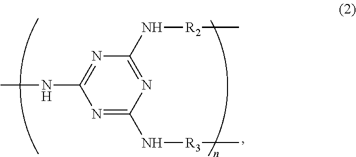
wherein in formula, R₂ and R₃ each independently represent a divalent organic group having an aromatic ring or a heterocyclic ring, and n is an integer of 3 or more.

6. The optical member according to claim 1,
wherein when the refractive indices of the first organic resin layer, the second organic resin layer, and the porous layer or the layer having an uneven structure are represented by n1, n2, and n3, respectively, n1>n2>n3 holds.

7. The optical member according to claim 1,
wherein the uneven structure includes a crystal containing aluminum oxide as a primary component.

8. The optical member according to claim 1,
wherein the porous layer includes silicon oxide particles.

9. The optical member according to claim 1,
wherein the substrate includes an inorganic glass.

10. An optical lens comprising:
a lens; and
a laminated body formed on a surface of the lens,
wherein the laminated body includes:
a porous layer or a layer having an uneven structure as a surface layer;
a first organic resin layer containing a polymer having an aromatic ring and/or an imide ring in its main chain as a primary component; and
a second organic resin layer containing a polymaleimide having a repeating structure represented by general formula (1) or a copolymer thereof as a primary component, the first organic resin layer and the second organic resin layer being provided in this order from the lens to the surface layer 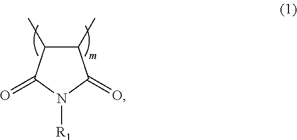
wherein in formula (1), R₁ represents a linear, a branched, or a cyclic alkyl or alkenyl group having a 1 to 8 carbon atoms which is unsubstituted or substituted by a phenyl group, a hydroxy group, an alkoxy group, an acetoxy group, a cyclic ether group, an amino group, an alkoxysilyl group, and/or a halogen atom, or a phenyl, a biphenyl, or a naphthyl group which is unsubstituted or substituted by an alkyl group, an alkenyl group, an alkoxy group, an acetoxy group, an alkoxysilyl group, a nitro group, and/or a halogen group, and m is an integer of 1 or more.

11. A method for manufacturing an optical member in which a laminated body is formed on a surface of a substrate, the method comprising the steps of:
applying a solution of a polymer having an aromatic ring and/or an imide ring in its main chain on the substrate, followed by performing drying at 20° C. to 150° C. to form a first organic resin layer;
applying a solution of a polymaleimide having a repeating structure represented by general formula (1) or a copolymer thereof on the first organic resin layer, followed by performing drying at 20° C. to 150° C. to form a second organic resin layer; and
forming a porous layer or a layer having an uneven structure on the second organic resin layer using a silicon oxide particle sol or an aluminum oxide precursor sol 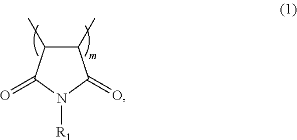
wherein in formula (1), R₁ represents a linear, a branched, or a cyclic alkyl or alkenyl group having a 1 to 8 carbon atoms which is unsubstituted or substituted by a phenyl group, a hydroxy group, an alkoxy group, an acetoxy group, a cyclic ether group, an amino group, an alkoxysilyl group, and/or a halogen atom, or a phenyl, a biphenyl, or a naphthyl group which is unsubstituted or substituted by an alkyl group, an alkenyl group, an alkoxy group, an acetoxy group, an alkoxysilyl group, a nitro group, and/or a halogen group, and m is an integer of 1 or more.

12. The method for manufacturing an optical member according to claim 11,
wherein the solution of a polymer having an aromatic ring and/or an imide ring in its main chain used in the step in which the first organic resin layer is formed contains 50 to 100 percent by mass of cyclohexanone, cyclopentanone, and γ-butyrolactone in total,
the solution of a polymaleimide or a copolymer thereof used in the step in which the second organic resin layer is formed contains 50 to 100 percent by mass of an acetic acid ester, a formic acid ester, and a lactic acid ester in total and 0 to less than 10 percent by mass of cyclohexanone, cyclopentanone, and γ-butyrolactone in total, and
the aluminum oxide precursor sol or the silicon oxide particle sol contains 80 to 100 percent by mass of an alcohol having 3 to 7 carbon atoms with respect to the total solvent.

13. The method for manufacturing an optical member according to claim 11,
wherein the step of forming a layer having an uneven structure comprises the substeps of:
applying the aluminum oxide precursor sol;
drying and/or firing the applied aluminum oxide precursor sol at 50° C. to 250° C. to form an aluminum oxide film; and
immersing the aluminum oxide film in hot water to form a layer having an uneven structure from a crystal containing aluminum oxide as a primary component.

14. The method for manufacturing an optical member according to claim 11,
wherein the step of forming a porous layer comprises the substeps of;
applying the silicon oxide particle sol; and
drying and/or firing the applied silicon oxide particle sol at 50° C. to 250° C. to form a layer from silicon oxide particles.
